(19) United States
(12) Patent Application Publication
(10) Pub. No.: US 2008/0095408 A1
(43) Pub. Date: Apr. 24, 2008

(54) IMAGING APPARATUS AND METHOD THEREOF

(75) Inventors: Masahiro Yokohata, Osaka City (JP); Yasuhachi Hamamoto, Moriguchi City (JP); Yukio Mori, Hirakata City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 11/876,078

(22) Filed: Oct. 22, 2007

(30) Foreign Application Priority Data
Oct. 23, 2006 (JP) JP2006-287170

(51) Int. Cl. G06K 9/00; H04N 5/228

(52) U.S. Cl. 382/106; 348/222.1; 348/E05.031

(57) ABSTRACT

There is provided an imaging apparatus and an imaging method capable of matching coordinate positions of a plurality of images to be synthesized with each other when generating an image having a wide dynamic range by synthesizing the plurality of images each having a different exposure condition. When a luminance adjustment circuit adjusts a luminance value of each of reference image data and non-reference image data, a displacement detection circuit detects displacement between the reference image data and non-reference image data. After a displacement correction circuit corrects coordinate positions of the non-reference image data on the basis of the detected displacement, an image synthesizing circuit generates synthesized image data composed of reference image data and non-reference image data.

### CROSS REFERENCE TO RELATED APPLICATIONS

This application claims the benefit of priority under 35 U.S.C. 119 of Japanese Patent Application No. P2006-287170 filed on Oct. 23, 2006, the entire contents of which are incorporated herein by reference.

### BACKGROUND OF THE INVENTION

1. Field of the Invention

The invention relates to an imaging apparatus and an imaging method that capture an image, and more particularly relates to an imaging apparatus and an imaging method that obtain an image with a large dynamic range.

2. Description of Related Art

Suppose a case where an image of a subject with a narrow dynamic range and a wide luminance range is captured with a solid-state image sensor such as a CCD (charge Coupled Device), a CMOS (Complementary Metal Oxide Semiconductor) sensor and the like. When the dynamic range is adjusted to a high luminance value, blackout occurs in a portion having a low luminance value. Conversely, when the dynamic range is adjusted to a low luminance value, whiteout occurs in a portion having a high luminance value. Japanese Patent Application Laid-Open Publication Nos. 2001-16499, 2003-163831 and 2003-219281 disclose used of a method in which multiple images, each having a different amount of exposure, are captured and synthesized to image a subject with a wide luminance range using a solid-state imaging apparatus having a narrow dynamic range.

In an imaging apparatus described in Japanese Patent Application Laid-Open Publication No. 2001-16499, arithmetic processing with different gamma characteristics is performed for signal levels obtained by alternately repeating long time and short time exposures. An offset is then added to the amount of signals obtained by the short time exposure and the resulting signals are added to the signals obtained by the long time exposure. By this means, the signals obtained by the long time exposure and obtained by the short time exposure are synthesized to generate an image signal having a wider dynamic range.

In the imaging apparatuses described in Japanese Patent Laid-Open Nos. 2003-163831 and 2003-219281, an image generated with long time exposure imaging and an image that is generated with short time exposure imaging are synthesized to generate a synthesized image having a wide dynamic range, similar to the apparatus described in Japanese Patent Laid-Open Nos. 2001-16499. Then, in order to suppress occurrence of blurring in the synthesized image, an electronic shutter and a mechanical shutter are combined to shorten a shutter interval for capturing two images for synthesis.

However, even if two images under each exposure condition are synthesized to thereby expand the dynamic range, a mismatch between coordinate positions of the two images is caused by camera shake during imaging, which results in occurrence of blurring in the synthesized image. The imaging apparatuses disclosed by publications 2003-163831 and 2003-219281 can shorten the shutter interval for synthesis of two images so as to suppress the displacement of the coordinate positions. However, the imaging apparatuses are not designed to match the coordinate positions with each other. Accordingly, blurring cannot be eliminated. Since blurring can still occur, the image quality of the synthesized image is eventually deteriorated.

### SUMMARY OF THE INVENTION

In view of the aforementioned problem, an object of the invention is to provide an imaging apparatus and an imaging method capable of matching coordinate positions of a plurality of images to be synthesized with each other when generating an image having a wide dynamic range by synthesizing the plurality of images each having a different exposure condition.

According to one aspect of the invention, there is provided an imaging apparatus that comprises a displacement detection unit configured to receive a reference image data of an exposure time and a non-reference image data of shorter exposure time than the exposure time of the reference image data, and to compare the reference image with the non-reference image to detect an amount of displacement; a displacement correction unit configured to correct the amount of displacement of the non-reference image data based upon the amount of displacement detected by the displacement detection unit; an image synthesizing unit configured to synthesize the reference image data with the non-reference image data corrected by the displacement from the displacement correction unit to generate the synthesized image data.

Another aspect of the invention, there is provided an imaging method that comprises, receiving a reference image data of an exposure time and a non-reference image data of shorter exposure time than the exposure time of the reference image data; comparing the reference image with the non-reference image to detect an amount of displacement; correcting displacement of the non-reference image data based upon the amount of displacement detected; and generating synthesized image data from the reference image data by correcting with non-reference image data and displacement data.

### BRIEF DESCRIPTION OF THE DRAWINGS

FIG. 1 is a general configuration view illustrating an imaging apparatus of each embodiment;

FIG. 2 is a block diagram illustrating an internal configuration of a wide dynamic range image generation circuit in an imaging apparatus according to a first embodiment;

FIG. 3 is a block diagram illustrating an internal configuration of a luminance adjustment circuit in FIG. 2;

FIG. 4 is a view illustrating a relationship between a luminance distribution of a subject, and reference image data and non-reference image data;

FIG. 5 is a block diagram illustrating an internal configuration of a displacement detection circuit in FIG. 2;

FIG. 6 is a block diagram illustrating an internal configuration of a representative point matching circuit in FIG. 5;

FIG. 7 is a view illustrating respective motion vector detection regions and their small regions, which are defined by the representative point matching circuit in FIG. 6;

FIG. 8 is a view illustrating a representative point and sampling points in each region illustrated in FIG. 7;

FIG. 9 is a view illustrating a representative point and a pixel position of a sampling point that correspond to a minimum accumulated correlation value in each region as illustrated in FIG. 7;

FIG. 10 is a view illustrating a position of a pixel corresponding to a minimum accumulated correlation value and positions of the neighborhood pixels;

FIG. 11 is a table summarizing output data of the arithmetic circuit in FIG. 6;

FIG. 12 is a flowchart illustrating processing procedures of a displacement detection circuit;

FIG. 13 is a flowchart illustrating processing procedures of the displacement detection circuit;

FIG. 14 is a view illustrating patterns of accumulated correlation values to which reference is made when selection processing of an adopted minimum accumulated correlation value is performed in step S17 in FIG. 12;

FIG. 15 is a flowchart specifically illustrating selection processing of an adopted minimum accumulated correlation value in step S17 in FIG. 12;

FIG. 16 is a specific block diagram illustrating a functional internal configuration of a displacement detection circuit;

FIG. 17 is a view illustrating a state of an entire motion vector between reference data and non-reference data to indicate a displacement correction operation by a displacement correction circuit;

FIG. 18 is a view illustrating a relationship between luminance of reference image data and non-reference image data, which are transmitted to an image synthesizing circuit, and a signal value;

FIG. 19 is a view illustrating a change in signal strength when reference image data and non-reference image data in FIG. 18 are synthesized by an image synthesizing circuit;

FIG. 20 is a view illustrating a change in signal strength when image data synthesized in FIG. 19B are compressed by an image synthesizing circuit;

FIG. 21 is a functional block view explaining an operation flow of the main components of the apparatus in a wide dynamic range imaging mode according to the first embodiment;

FIG. 22 is a block diagram illustrating an internal configuration of a wide dynamic range image generation circuit in an imaging apparatus according to a second embodiment;

FIG. 23 is a functional block view explaining a first example of an operation flow of the main components of the apparatus in a wide dynamic range imaging mode according to a second embodiment;

FIG. 24 is a functional block view explaining a second example of an operation flow of the main components of the apparatus in a wide dynamic range imaging mode according to a second embodiment; and

FIG. 25 is a functional block view explaining a third example of an operation flow of the main components of the apparatus in a wide dynamic range imaging mode according to a second embodiment.

### DETAILED DESCRIPTION OF EMBODIMENTS

### <Configuration of Imaging Apparatus>

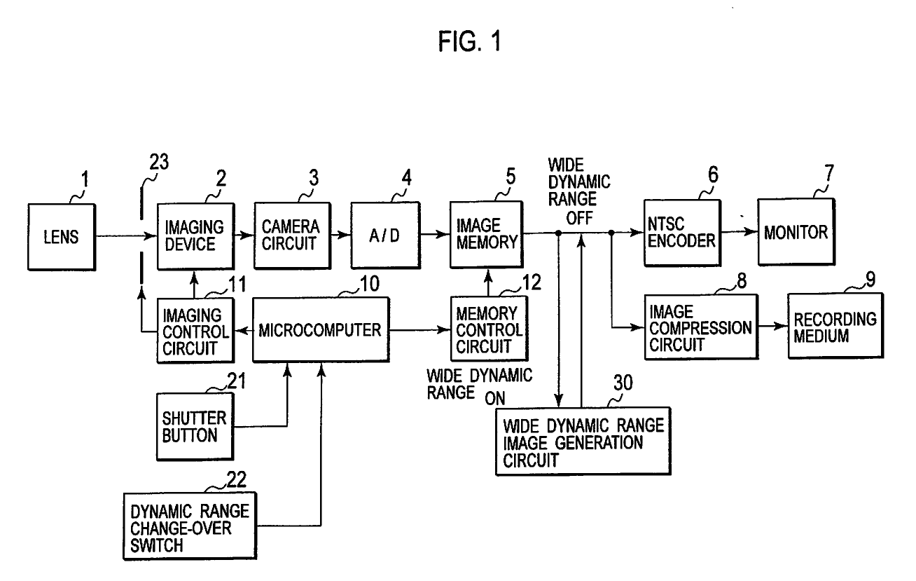

An explanation will be given of a configuration of an imaging apparatus common to the respective embodiments with reference to the drawings. FIG. 1 is a general configuration view illustrating the imaging apparatus of each embodiment. Moreover, the imaging apparatus in FIG. 1 is a digital still camera or digital video camera, which is capable of capturing at least a still image.

The imaging apparatus in FIG. 1 includes lens 1 on which light from a subject is incident; imaging device 2 that includes a CCD or a CMOS sensor performing photoelectric conversion of an optical image incident on lens 1, and the like; camera circuit 3 that performs each arithmetic processing on an electrical signal obtained by the photoelectric conversion processing in imaging device 2; A/D converter 4 that converts an output signal from camera circuit 3 into image data as a digital image signal; image memory 5 that stores image data from A/D conversion circuit 4; NTSC encoder 6 that converts a given image data into a NTSC (National Television Standards Committee) signal; monitor 7 that includes a liquid crystal display for reproducing and displaying an image on the basis of a NTSC signal from NTSC encoder 6, and the like; image compression circuit 8 that encodes a given image data in a predetermined compression data format such as JPEG (Joint Photographic Experts Group); recording medium 9 that includes a memory card for storing the image data, serving as an image file, encoded by image compression circuit 8; microcomputer 10 that controls the entirety of the apparatus; imaging control circuit 11 that sets an exposure time of imaging device 2; and memory control circuit 12 that controls image memory 5.

In the above-configured imaging apparatus, imaging device 2 performs photoelectric conversion of the optical image incident on lens 1 and outputs the optical image as an electrical signal serving as a RGB signal. Then, when the electrical signal is transmitted to camera circuit 3 from imaging device 2, in camera circuit 3, the transmitted electrical signal is first subjected to correlated double sampling by a CDS (Correlated Double Sampling) circuit and the resultant signal is subjected to gain adjustment to optimize amplitude by an AGC (Auto Gain Control) circuit. The output signal from camera circuit 3 is converted into image data as a digital image signal by A/C conversion circuit 4 and the resultant signal is written in image memory 5.

The imaging apparatus in FIG. 1 further includes a shutter button 21 for imaging, a dynamic range change-over switch 22 that changes a dynamic range of imaging device 2, a mechanical shutter 23 that controls light incident on imaging device 2, and a wide dynamic range image generation circuit 30 that is operated when the wide dynamic range is required by dynamic range change-over switch 22.

Furthermore, operation modes, which are used when the imaging apparatus performs imaging, include a “normal imaging mode” wherein a dynamic range of an image file is a dynamic range of imaging device 2, and a “wide dynamic range imaging mode” wherein the dynamic range of the image file is made electronically wider than the dynamic range of imaging device 2. Then, selection setting of the “normal imaging mode” and the “dynamic range imaging mode” is carried out in response to the operation of dynamic range change-over switch 22.

When the apparatus is thus configured and the “normal imaging mode” is designated to microcomputer 10 by dynamic range change-over switch 22, microcomputer 10 provides operational control to imaging control circuit 11 and memory control circuit 12 in such a way to carry out the operation corresponding to the “normal imaging mode.” Moreover, imaging control circuit 11 controls the shutter operation of mechanical shutter 23 and the signal processing operation of imaging device 2 in accordance with each mode, and memory control circuit 12 controls the image data writing and reading operations to and from image memory 5 in accordance with each mode. Furthermore, imaging control circuit 11 sets an optimum exposure time of imaging device 2 on the basis of information of brightness obtained from a photometry circuit (not shown) that measures brightness of a subject.

First, an explanation will be given of the operation of the imaging apparatus when the normal imaging mode is set by dynamic range change-over switch 22. When shutter button 21 is not pressed, imaging control circuit 11 sets electronic shutter exposure time and signal reading time for imaging device 2, so that imaging device 2 performs imaging for a fixed period of time (for example, 1/60 sec). Image data obtained by imaging performed by imaging device 2 is written in image memory 5 and the written image data is converted into the NTSC signal by NTSC encoder 6 and the result is sent to monitor 7 including such as the liquid crystal display and the like. At this time, memory control circuit 12 controls image memory 5 to write the image data from A/C conversion circuit 4 and NTSC encoder 6 to read the written image. Then, the image represented by each image data is displayed on monitor 7. Such image data written in image memory 5 and directly sent to NTSC encoder 6 is called “through display.”

When shutter button 21 is pressed, imaging control circuit 11 controls the electronic shutter operation and the signal reading operation and the opening and closing operation of mechanical shutter 23 in imaging device 2. By this means, imaging device 2 starts capturing a still image and image data, which has been obtained at the timing when the still image is captured, is written in image memory 5. After that, the image represented by the image data is displayed on monitor 7 and the image data is encoded in a predetermined compression data format such as JPEG by image compression circuit 8 and the encoded result, serving as an image file, is stored in memory card 9. At this timing, memory control circuit 12 controls image memory 5 to store the image data from A/C conversion circuit 4, and NTSC encoder 6 and image compression circuit 8 to read the written image data.

Next, an explanation will be given of the operation of the imaging apparatus when the wide dynamic range imaging mode is set by dynamic range change-over switch 22. The following will explain the operation in the wide dynamic range imaging mode unless specified otherwise.

When shutter button 21 is not pressed, through display is performed, similar to the normal imaging mode. In other words, image data obtained by imaging performed by imaging device 2 for a fixed period of time (for example, 1/60 sec) is written to image memory 5 and transmitted to monitor 7 through NTSC encoder 6. Moreover, the image data written in image memory 5 is also transmitted to wide dynamic range image generation circuit 30 and an amount of displacement of coordinate positions are detected for each frame. Then, the detected amount of displacement is temporarily stored in wide dynamic range image generation circuit 30 when imaging is performed in the wide dynamic range.

Furthermore, when shutter button 21 is pressed, imaging control circuit 11 controls the electronic shutter operation and the signal reading operation and the opening and closing operation of mechanical shutter 23 in imaging device 2. Then, when image data of multiple frames each having a different amount of exposure are continuously captured by imaging device 2 as in each of the embodiments described later, the captured image data is sequentially written in image memory 5. When the written image data of multiple frames is transmitted to wide dynamic range image generation circuit 30 from image memory 5, displacement of coordinate positions of the image data of two frames, each having a different amount of exposure, is corrected, and the image data of two frames are synthesized to generate synthesized image data having a wide dynamic range.

Then, the synthesized image data generated by wide dynamic range image generation circuit 30 is transmitted to NTSC encoder 6 and image compression circuit 8. At this time, the synthesized image data are transmitted to monitor 7 through NTSC encoder 6, whereby a synthesized image, having a wide dynamic range, is reproduced and displayed on monitor 7. Moreover, image compression circuit 8 encodes the synthesized image data in a predetermined compression data format and stores the resultant data, serving as an image file, in memory card 9.

Details on the imaging apparatus configured and operated as mentioned above will be explained in each of the following embodiments. Noted that the foregoing configuration and operation relating to the “normal imaging mode” are common to those in the respective embodiments, and therefore the following will specifically explain the configuration and operation relating to the “wide dynamic range imaging mode.”

### First Embodiment

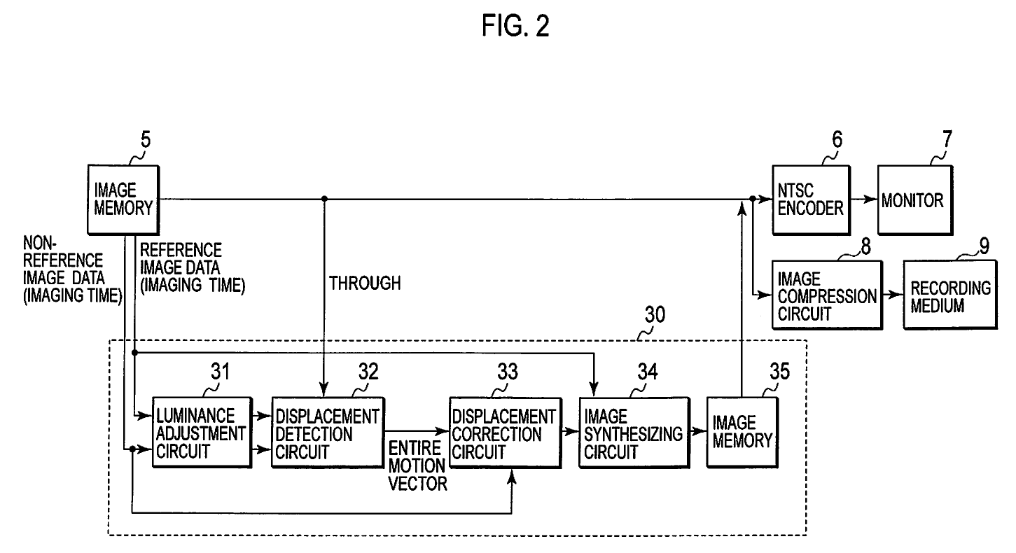

A first embodiment will be explained with reference to the drawings. FIG. 2 is a block diagram illustrating an internal configuration of wide dynamic range image generation circuit 30 in an imaging apparatus according to the first embodiment.

Wide dynamic range image generation circuit 30 in the imaging apparatus of this embodiment, as illustrated in FIG. 2, includes a luminance adjustment circuit 31 that adjusts a luminance value of reference image data and that of non-reference image data for generating synthesized image data; displacement detection circuit 32 that detects displacement in coordinate positions between reference image data and non-reference image data subjected to gain adjustment by luminance adjustment circuit 31; displacement correction circuit 33 that corrects the coordinate positions of non-reference image data on the basis of the displacement detected by displacement detection circuit 32; image synthesizing circuit 34 that synthesizes the reference image data with non-reference image data, whose coordinate positions have been corrected by the displacement correction circuit 33, to generate synthesized image data; and an image memory 35 that temporarily stores synthesized image data obtained by the image synthesizing circuit 34.

As mentioned above, in the case of the wide dynamic range imaging mode set by the dynamic range change-over switch 22, when the shutter button 21 is not pressed, the imaging device 2 performs imaging for a fixed period of time and an image based on the image data is reproduced and displayed on the monitor 7. At this time, the image data written in the image memory 5 is transmitted to not only the NTSC encoder 6 but also to the wide dynamic range image generation circuit 30.

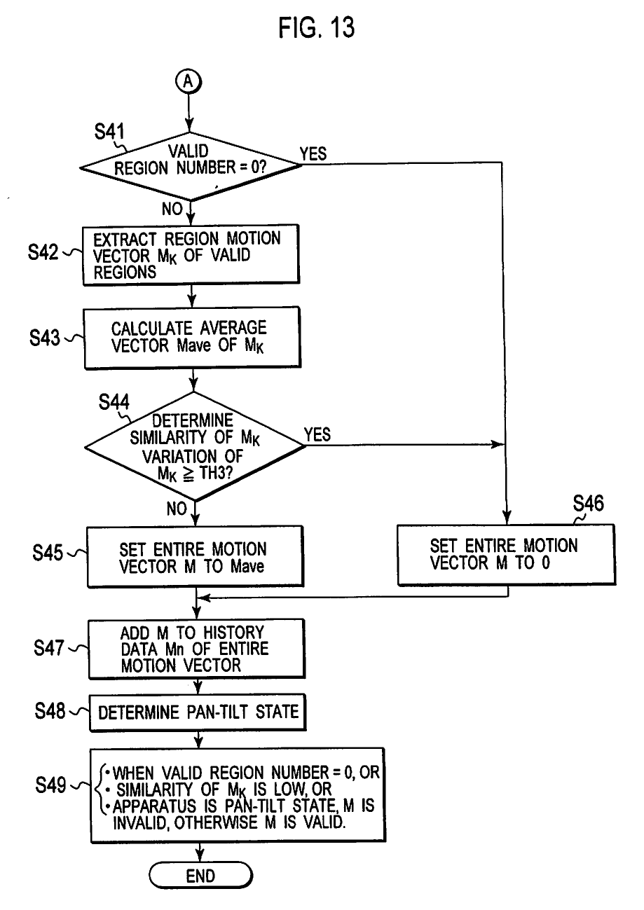

In the wide dynamic range image generation circuit 30, the image data written in the image memory 5 is transmitted to the displacement detection circuit 32 to calculate a motion vector between two frames on the basis of image data of two different input frames. In other words, displacement detection circuit 32 calculates the motion vector between the image represented by image data of the previously input frame and the image represented by image data of the currently input frame. Then, the calculated motion vector is temporality stored with the image data of the currently input frame. Additionally, motion vectors sequentially calculated when shutter button 21 is not pressed are used in processing (pan-tilt state determination processing) in step S48 in FIG. 13 to be described later.

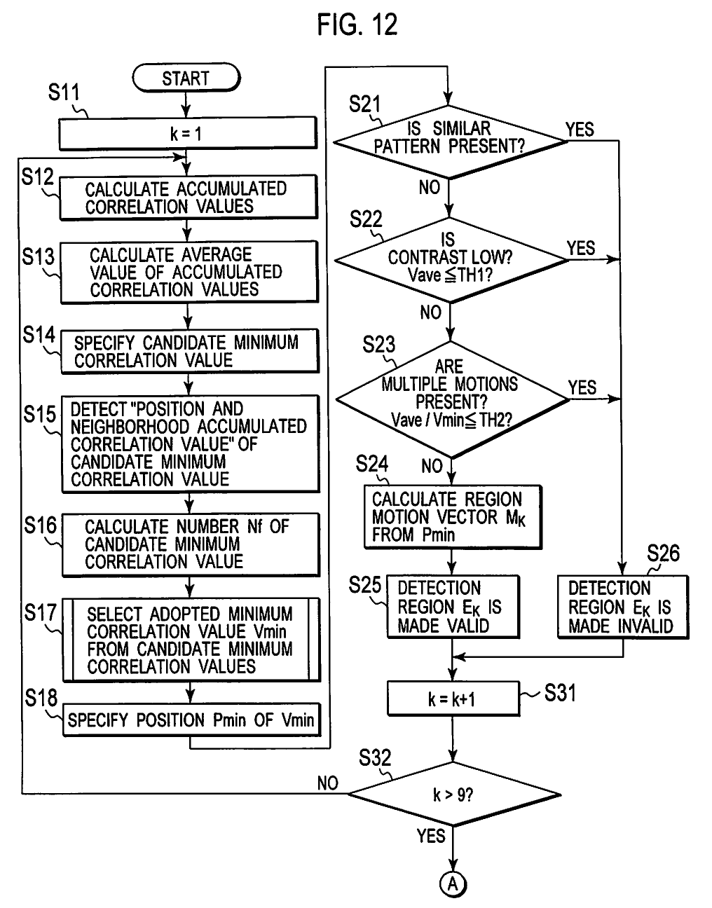

To simplify the following explanation, a case is described in which the reference image data and the non-reference image data are input to wide dynamic range image generation circuit 30. However, processing shown in FIGS. 12 and 13, to be described later, is sequentially carried out in wide dynamic range imaging mode regardless of whether shutter button 21 is pressed. Then, when shutter button 21 is not pressed, the image data of the previous frame is used as reference image data and the image data of the current frame is used as non-reference image data, and the similar operation is carried out. Moreover, when shutter button 21 is not pressed, the image data is transmitted to displacement detection circuit 32 without being subjected to luminance adjustment by luminance adjustment circuit 31 and the motion vector is calculated.

When shutter button 21 is pressed, microcomputer 10 instructs imaging control circuit 11 to perform imaging in a frame with a long exposure time and imaging in a frame with a short exposure time in combination of the electronic shutter function and the opening and closing operations of mechanical shutter 23 in imaging device 2. Then, image data of the frame with a long exposure time is used as reference image data and image data of the frame with a short exposure time is used as non-reference image data, the frame corresponding to the non-reference image data is first captured and the frame corresponding to the reference image data is next captured. Then, the reference image data and non-reference image data stored in image memory 5 are transmitted to luminance adjustment circuit 31.

### (Luminance Adjustment Circuit)

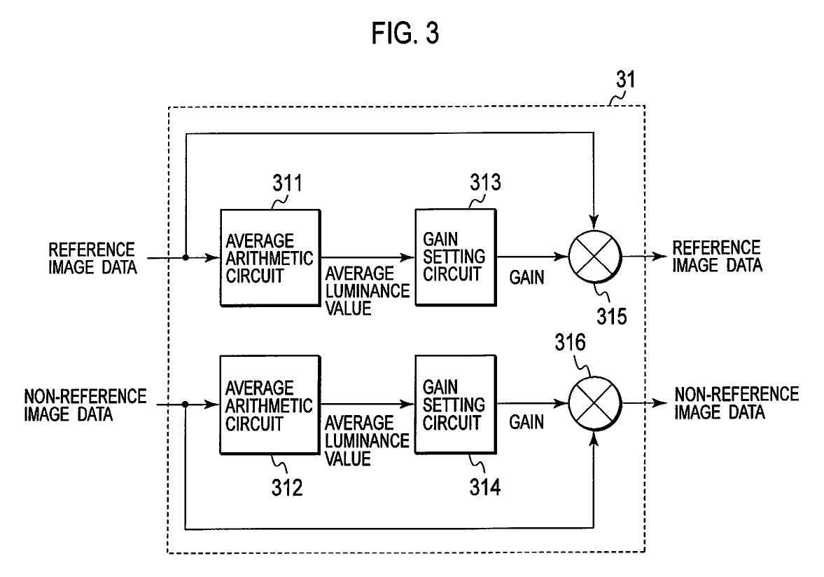

Luminance adjustment circuit 31 provides gain adjustment to the reference image data and the non-reference image data in such a way to equalize an average luminance value of the reference image data and that of the non-reference image data. More specifically, as illustrated in FIG. 3, luminance adjustment circuit 31 includes average arithmetic circuits 311 and 312, each of which obtains average luminance values of the reference image data and the non-reference image data; gain setting circuits 313 and 314 each of which performs gain setting on the basis of the average luminance value obtained by each of average arithmetic circuits 311 and 312; and multiplying circuits 315 and 316 each of which adjusts a luminance value of each of the reference image data and the non-reference image data by multiplying by the gain set by each of gain setting circuits 313 and 314.

In luminance adjustment circuit 31, average arithmetic circuits 311 and 312 set luminance ranges for used for computation use in order to obtain average luminance values. Then, assuming that the luminance range set by average arithmetic circuit 311 is defined as L1 or more and L2 or less where a whiteout portion can be neglected and the luminance range set by average arithmetic circuit 312 is defined as L3 or more and L4 or less where a blackout portion can be neglected. Additionally, average arithmetic circuits 311 and 312 set luminance ranges L1 to L2 (indicating L1 or more and L2) and L3 to L4 (indicating L3 or more and L4 or less), respectively, on the basis of a ratio of exposure time for imaging the reference image data to that for imaging the non-reference image data.

In other words, when exposure time for imaging the reference image data is T1 and exposure time for imaging the non-reference image data is T2, a maximum value L4 of the luminance range in average arithmetic circuit 312 is set by multiplying a maximum value L2 of the luminance range in average arithmetic circuit 311 by (T2/T1). By this means, maximum value L4 of the luminance range in average arithmetic circuit 312 is set on the basis of maximum value L2 of the luminance range in average arithmetic circuit 311 in order to eliminate the whiteout portion in the reference image data.

Moreover, a minimum value L1 of the luminance range in average arithmetic circuit 311 is set by multiplying a minimum value L3 of the luminance range in average arithmetic circuit 312 by (T2/T1). By this means, minimum value L1 of the luminance range in average arithmetic circuit 311 is set on the basis of minimum value L3 of the luminance range in average arithmetic circuit 312 in order to eliminate the blackout portion in the non-reference image data.

Then, in averaging arithmetic circuit 311, a luminance value, which satisfies luminance ranges L1 to L2 in the reference image data, is accumulated and the accumulated luminance value is divided by the selected number of pixels, thereby obtaining an average luminance value Lav1 of the reference image data. Likewise, in averaging arithmetic circuit 312, a luminance value, which satisfies the luminance ranges L3 to L4 in the non-reference image data, is accumulated and the accumulated luminance value is divided by the selected number of pixels, thereby obtaining an average luminance value Lav2 of the non-reference image data.

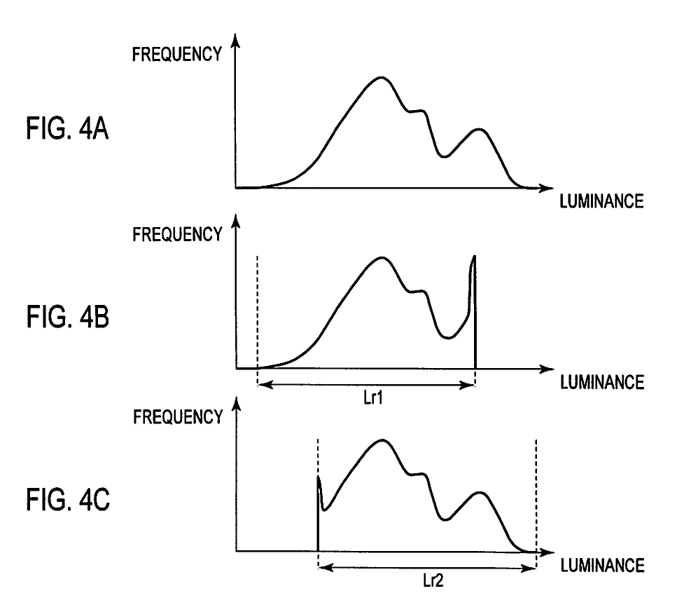

In other words, when a subject with a luminance distribution as shown in FIG. 4 is imaged, the luminance range of reference image data obtained by imaging with exposure time T1 is changed to luminance range Lr1 as illustrated in FIG. 4B, so that a pixel distribution on a high luminance side of the luminance range is increased and the whiteout occurs. Therefore, maximum luminance value L2 in luminance ranges L1 to L2 is set in order to eliminate the whiteout portion from the luminance range for performing the average value computation. Then, maximum luminance value L4 in luminance ranges L3 to L4 of the non-reference image data is set on basis of this maximum luminance value L2 as mentioned above.

Moreover, the luminance range of non-reference image data obtained by imaging with exposure time T2 is changed to luminance range Lr2 as illustrated in FIG. 4C, so that a pixel distribution on a low luminance side of the luminance range is increased and the blackout occurs. Therefore, a minimum luminance value L3 in the luminance ranges L3 to L4 is set in order to eliminate the blackout portion from the luminance range for performing the average value computation. Then, the minimum luminance value L1 in luminance ranges L1 to L2 of the reference image data is set on the basis of this minimum luminance value L3 as mentioned above.

Note that, for convenience of explanation, luminance range Lr1 in FIG. 4B and luminance range Lr2 in FIG. 4C presumable are adjusted to the luminance distribution of the subject in FIG. 4. Luminance values L1 to L4, Lac1, Lav2 and Lth in the specification presumable are luminance values based on the amount of exposure to imaging device 2. In other words, the luminance value adjusted by luminance adjustment circuit 31 is the image data value from imaging device 2 that is proportional to the amount of exposure to imaging device 2.

Accordingly, in the luminance distribution of the subject in FIG. 4A, average arithmetic circuit 311 obtains an average luminance value Lav1, which is based on the luminance distribution in the luminance ranges L1 to L2, with respect to the reference image data obtained by imaging the luminance range Lr1 as illustrated in FIG. 4B. Namely, in average arithmetic circuit 311, a luminance value, which satisfies the luminance ranges L1 to L2 in the reference image data, is accumulated and the number of pixels having a luminance value, which satisfies the luminance ranges L1 to L2, is calculated. The accumulated luminance value is divided by the number of pixels, thereby obtaining an average luminance value Lav1 of the reference image data.

Moreover, in the luminance distribution of the subject in FIG. 4A, average arithmetic circuit 312 obtains an average luminance value Lav2, which is based on the luminance distribution in the luminance ranges L3 to L4, with respect to the non-reference image data obtained by imaging the luminance range Lr2 as illustrated in FIG. 4C. Namely, in average arithmetic circuit 312, a luminance value, which satisfies the luminance ranges L3 to L4 in the non-reference image data, is accumulated and the number of pixels having a luminance value, which satisfies the luminance ranges L3 to L4, is calculated. The accumulated luminance value is divided by the number of pixels, thereby obtaining an average luminance value Lav2 of the non-reference image data.

The thus obtained average luminance values Lav1 and Lav2 of the reference image data and the non-reference image data are transmitted to gain setting circuits 313 and 314, respectively. The gain setting circuit 313 performs a comparison between the average luminance value Lav1 of reference image data and a reference luminance value Lth, and sets a gain G1 to be multiplied by multiplying circuit 315. Likewise, gain setting circuit 314 performs a comparison between the average luminance value Lav2 of non-reference image data and a reference luminance value Lth, and sets a gain G2 to be multiplied by multiplying circuit 316.

At this time, for example, the gain G is defined as a ratio (Lth/Lav1) between the average luminance value Lav1 and the reference luminance value Lth in gain setting circuit 313 and the gain G2 is defined as a ratio (Lth/Lav2) between the average luminance value Lav2 and the reference luminance value Lth in gain setting circuit 314. Then, the gains G1 and G2 set by gain setting circuits 313 and 314 are transmitted to multiplying circuits 315 and 316, respectively. By this means, multiplying circuit 315 multiplies the reference image data by the gain G1 and multiplying circuit 316 multiplies the non-reference image data by the gain G2. Accordingly, the average luminance values of the reference image data and the non-reference image data processed by each of multiplying circuits 315 and 316 becomes substantially equal to each other.

In this way, by operating the respective circuit components that make up luminance adjustment circuit 31, the reference image data and non-reference image data, both having substantially equal average luminance value, are transmitted to displacement detection circuit 32. Furthermore, the reference luminance value Lth is transmitted to gain setting circuits 313 and 314 in luminance adjustment circuit 31 by microcomputer 10 and the value of the reference luminance value Lth is changed, thereby making it possible to adjust the values of gain G1 and G2 to be set by gain setting circuits 313 and 314. Accordingly, the value of the reference luminance value Lth is adjusted by microcomputer 10, whereby the values of the gains G1 and G2 can be optimized on the basis of a ratio of whiteout contained in the reference image data and a ratio of blackout contained in the non-reference image data. Therefore, it is possible to provide reference image data and non-reference image data that are appropriate for arithmetic processing in displacement detection circuit 32.

Additionally, when either the reference image data or the non-reference image data, instead of both, is subjected to luminance adjustment as in the aforementioned luminance adjustment circuit 31 in order to substantially equalize the average luminance values of the reference image data and the non-reference image data, errors due to an S/N ratio and a signal linearity increase, which will decrease accuracy in displacement detection of a representative point matching as described below. An influence of the errors due to the S/N ratio and the signal linearity becomes large when there is a large difference between exposure time for obtaining the reference image data and that for obtaining the non-reference image data, that is, a dynamic range expansion factor becomes large.

In contrast to this, in the foregoing luminance adjustment circuit 31, since both the reference image data and the non-reference image data are subjected to luminance adjustment, the reference luminance value Lth is set to be an intermediate value of each average luminance value, so that each luminance adjustment can be carried out. Accordingly, even when there is a large difference between exposure time for obtaining the reference image data and that for obtaining the non-reference image data, it is possible to prevent expansion of the errors due to the S/N ratio and the signal linearity and deterioration in displacement detection accuracy.

### (Displacement Detection Circuit)

In displacement detection circuit 32 to which reference image data and non-reference image data, having luminance values adjusted in this way, are transmitted, a motion vector between the reference image and the non-reference image is calculated and it is determined whether the calculated motion vector is valid or invalid. Although details will be described later, a motion vector which is determined to be reliable to some extent as a vector representing a motion between the images is valid, and a motion vector which is not determined to be reliable is invalid (details will be described later). In addition, the motion vector discussed here corresponds to an entire motion vector between images (“entire motion vector” to be described later). Furthermore, displacement detection circuit 32 is controlled by microcomputer 10 and each value calculated by displacement detection circuit 32 is sent to microcomputer 10 as required.

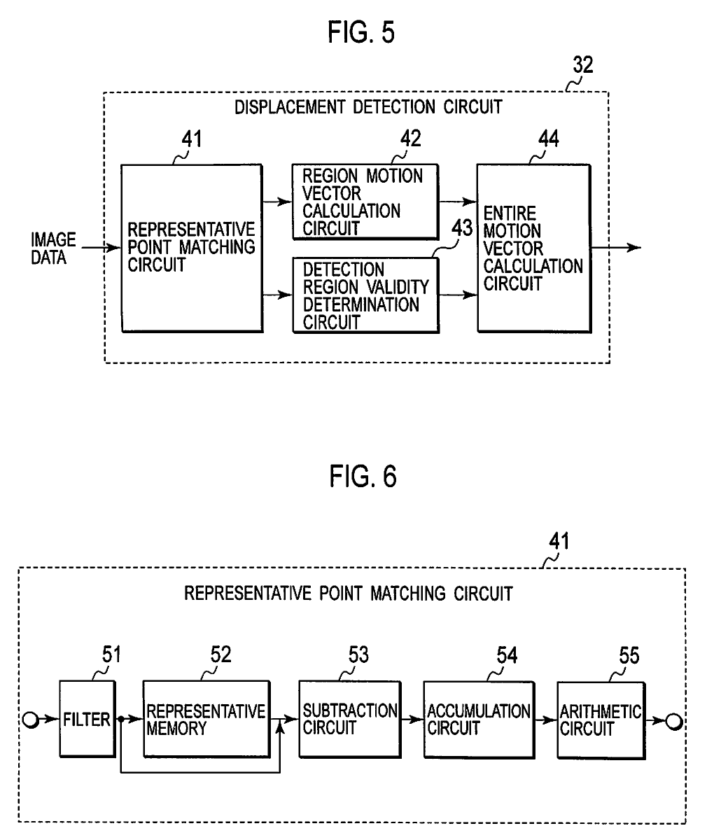

As illustrated in FIG. 5, displacement detection circuit 32 includes representative point matching circuit 41, regional motion vector calculation circuit 42, detection region validity determination circuit 43, and entire motion vector calculation circuit 44. Although functions of components indicated by reference numerals 42 to 44 will be explained using flowcharts in FIGS. 12 and 13 shown below, representative point matching circuit 41 will be specifically explained first. FIG. 6 is an internal block of a representative point matching circuit 41. Representative point matching circuit 41 includes a filter 51, a representative point memory 52, a subtraction circuit 53, an accumulation circuit 54, and an arithmetic circuit 55.

### 1. Representative Point Matching Method

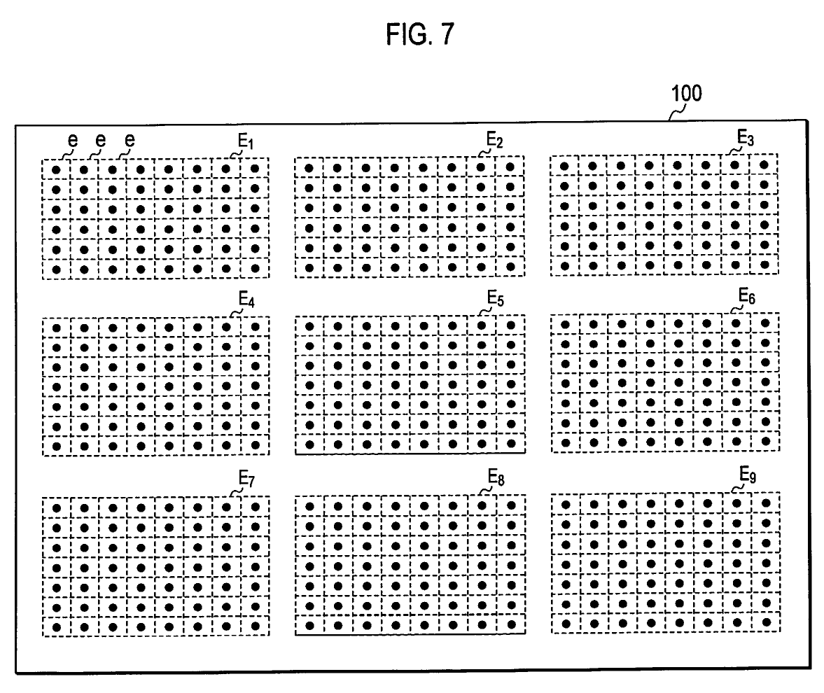

Displacement detection circuit 32 detects a motion vector and the like on the basis of the well-known representative point matching method. When reference image data and non-reference image data are input to displacement detection circuit 32, displacement detection circuit 32 detects a motion vector between a reference image and a non-reference image. FIG. 7 illustrates an image 100 that is represented by image data transmitted to displacement detection circuit 32. Image 100 shows, for example, either the aforementioned reference image or non-reference image. In image 100, a plurality of motion vector detection regions are provided. The motion vector detection regions hereinafter are simply referred to as “detection regions.”

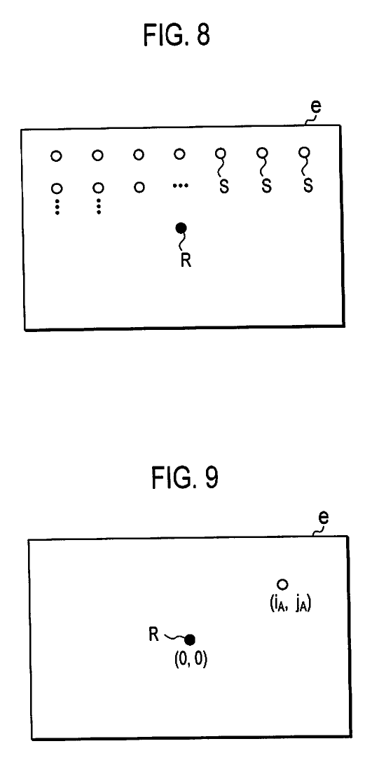

More specifically, suppose that nine detection regions E₁ to E₉ are provided. In this case, the sizes of the respective detection regions E₁ to E₉ are the same. Each of the detection regions E₁ to E₉ is further divided into a plurality of small regions e (detection blocks). In an example illustrated in FIG. 7, each detection region is divided into 48 small regions e (each detection region is divided into six in a vertical direction and eight in a horizontal direction). Each small region e comprises, for example, 32×32 pixels (pixels where vertical 32 pixels×horizontal 32 pixels are two-dimensionally arranged). Then, as illustrated in FIG. 8, in each small region e, a plurality of sampling points S and one representative point R are provided. Regarding a certain one small region e, for example, a plurality of sampling points S corresponds to all pixels that form the small region e (note that a representative point R is excluded).

An absolute value of a difference between a luminance value of each sampling point S in the small region e of the non-reference image and a luminance value of the representative point R in the small region e of the reference image is obtained for each of the detection regions E₁ to E₉ with respect to all small regions e. Then, for each of the detection regions E₁ to E₉, correlation values of sampling points S having the same shift to the representative point R are accumulated in each of the small regions e of one detection region (in this example, 48 correlation values are accumulated). Namely, in each of the detection regions E₁ to E₉, absolute values, each indicating an absolute value of luminance difference obtained for the pixel placed at the same position in each small region e, (same position of the coordinates in the small region), are accumulated with respect to 48 small regions. A value obtained by this accumulation is termed “accumulated correlation value.” The accumulated correlation value is generally termed a “matching error.” The accumulated correlation values, whose number is the same as the number of sampling points S in one small region, are obtained for each of the detection regions E₁ to E₉.

Then, in each of the detection regions E₁ to E₉, a shift between the representative point R and sampling point S that has a minimum accumulated correlation value, namely, a shift having the highest correlation is detected. In general, the shift is extracted as the motion vector of the corresponding detection region. Thus, regarding a certain detection region, the accumulated correlation value calculated on the basis of the representative point matching method indicates correlation (similarity) between the image of the detection region in the reference image and the image of the detection region in the non-reference image when a predetermined shift (relative positional shift between the reference image and the non-reference image) to the non-reference image is added to the reference image, and the value becomes small as the correlation increases.

The operation of the representative point matching circuit 41 is specifically explained with reference to FIG. 6. Reference image data and non-reference data transferred from image memory 5 in FIG. 1 are sequentially input to filter 51 and each image data is transmitted to representative point memory 52 and subtraction circuit 53 through filter 51. Filter 51 is a lowpass filter, which is used to improve the S/N ratio and ensure sufficient motion vector detection accuracy with a small number of representative points. Representative point memory 52 stores position data, which specifies the position of the representative point R on the image, and luminance data, which specifies the luminance value of the representative point R, for every small region e of each of the detection regions E₁ to E₉.

In addition, the content of storage interval of representative point memory 52 can be updated at any timing interval. Every time the reference image data and the non-reference image data are respectively input to representative point memory 52, the storage contents can be updated and only when the reference image data is input, the content of storage may be updated. Moreover, for a specific pixel (representative point R or sampling point S), it is assumed that a luminance value indicates luminance of the pixel and the luminance increases as the luminance value increases. Moreover, suppose that the luminance value is expressed as a digital value of 8 bits (0 to 255). The luminance value may be, of course, expressed by the number of bits other than 8 bits.

Subtraction circuit 53 performs subtraction between the luminance value of representative point R of the reference image transmitted from representative point memory 52 and the luminance value of each sampling point S of the non-reference image and outputs an absolute value of the result. The output value of the subtraction circuit 53 represents the correlation value at each sampling point S and this value is sequentially transmitted to accumulation circuit 54. Accumulation circuit 54 accumulates the correlation values output from subtraction circuit 53 to thereby calculate and output the foregoing accumulated correlation value.

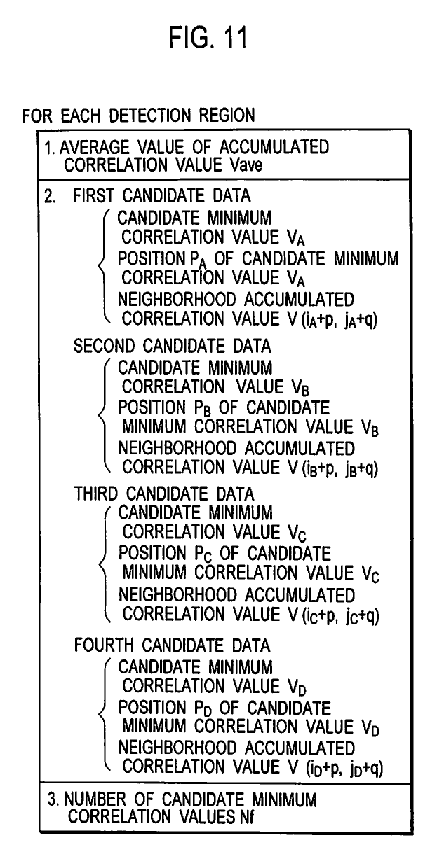

Arithmetic circuit 55 receives the accumulated value from the accumulation circuit 54 and calculates and outputs data as illustrated in FIG. 11. Regarding the comparison between the reference image and the non-reference image, a plurality of accumulated correlation values according to the number of sampling points S in one small region e (the plurality of accumulated correlation values are hereinafter referred to as “calculation target accumulated correlation value group) is transmitted to arithmetic circuit 55 for each of the detection regions E₁ to E₉. Arithmetic circuit 55 calculates, for each of the detection regions E₁ to E₉, an average value Vave of all accumulated correlation values that form the calculation target accumulated correlation value group, a minimum value of all accumulated correlation values that form a calculation target accumulated correlation value group, and a position P_{A} of a pixel indicating the minimum value and accumulated correlation values corresponding to pixels in the neighborhood of the pixel of the position P_{A} (hereinafter sometimes called neighborhood accumulated correlation value).

Attention is paid to each small region e and the pixel position and the like are defined as follows. In each small region e, a pixel position of the representative point R is represented by (0, 0). The position P_{A} is a pixel position of the sampling position S that provides the minimum value with reference to the pixel position (0, 0) of the representative point R. This is represented by (i_{A}, j_{A}) (see FIG. 9). The neighborhood pixels of the position P_{A} are peripheral pixels of the pixel of the position P_{A} including pixels adjacent to the pixel of the position P_{A}, and 24 neighborhood pixels located around the pixel of position P_{A} are assumed in this example.

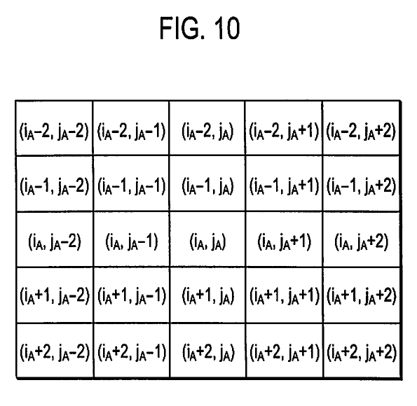

Then, as illustrated in FIG. 10, the pixel at position P_{A} and 24 neighborhood pixels form a pixel group arranged in a 5×5 matrix form. The pixel position of each pixel of the formed pixel group is represented by (i_{A}+P, j_{A}+q) . The pixel of the position Pa is present at the center of the pixel group. Moreover, p and q are integers and an inequality, −2≦p≦2 and <2≦q≦2, is established. The pixel position moves from up to down as p increases from −2 to 2 with center at the position P_{A}, and the pixel position moves from left to right as q increases from −2 to 2 with center at the position P_{A}. Then, the accumulated correlation value corresponding to the pixel position (i_{A}+P, j_{A}+q) is represented by V (i_{A}+p, j_{A}+q).

Generally, the motion vector is calculated according to the condition wherein position P_{A} of the minimum accumulated correlation value corresponds to the real matching position. However, in this example, the minimum accumulated correlation value is a candidate of the acuminated correlation value that corresponds to the real matching position. The minimum accumulated correlation value obtained at the position P_{A} is represented by V_{A}. This is called “candidate minimum accumulated value V_{A}.” Therefore, an equation, V (i_{A}, j_{A})=V_{A}, is established.

In order to specify another candidate, e arithmetic circuit 55 searches whether an accumulated correlation value close to the minimum accumulated correlation value V_{A} is included in the calculation target accumulated correlation value group and thereby specifies the searched accumulated correlation value close to V_{A} as a candidate minimum correlation value. The “accumulated correlation value close to the minimum accumulated correlation value V_{A}” is an accumulated correlation value. The accumulated correlation value is a value obtained by increasing V_{A} according to a predetermined rule, or less than the value, and for example, this includes an accumulated correlation value corresponding to a value or less than the value, obtained by adding a predetermined candidate threshold value (e.g., 2) to V_{A} or an accumulated correlation value corresponding to a value or less than the value, obtained by multiplying V_{A} by a coefficient of more than 1. The number of candidate minimum correlation values to be specified is, for example, four, at the maximum, including the foregoing minimum accumulated correlation value V_{A}.

For convenience of explanation, the following will describe a case in which candidate minimum accumulated correlation values V_{B}, V_{C}, and V_{D} are specified in addition to the candidate minimum accumulated correlation value V_{A} with respect to each of the detection regions E₁ to E₉. Additionally, although it has been explained that the accumulated correlation value close to the accumulated correlation value V_{A} is searched to thereby specify the other candidate accumulated correlation value, there is a case in which any one of V_{B}, V_{C}, and V_{D} is equal or all are equal to V_{A}. In such case, regarding a certain detection region, two or more minimum accumulated correlation values are included in the calculation target accumulated correlation value group.

Similar to the candidate minimum accumulated correlation value V_{A}, the arithmetic circuit 55 calculates, for each of the detection regions E₁ to E₉, a position P_{B} of a pixel indicating the candidate minimum correlation value V_{B} and 24 accumulated correlation values corresponding to 24 pixels in the neighborhood of the pixel of the position P_{B} (hereinafter sometimes called neighborhood accumulated correlation value), a position P_{C} of a pixel indicating the candidate minimum correlation value V_{C} and 24 accumulated correlation values corresponding to 24 pixels in the neighborhood of the pixel of the position P_{C} (hereinafter sometimes called neighborhood accumulated correlation value), and a position P_{D} of a pixel indicating the candidate minimum correlation value V_{D} and 24 accumulated correlation values corresponding to 24 pixels in the neighborhood of the pixel of the position P_{D} (hereinafter sometimes called neighborhood accumulated correlation value) (see FIG. 11).

Attention is paid to each small region e and the pixel position and the like are defined as follows. Similar to the position P_{A}, each of the position P_{B}, P_{C} and P_{D} is a pixel position of sampling position S that provides each of the candidate minimum correlation values V_{B}, V_{C} and V_{D} with reference to the pixel position (0, 0) of the representative point R and they are represented by (i_{B}, j_{B}) , (i_{C}, j_{C}) and (i_{D}, j_{D}), respectively. At this time, similar to the position P_{A}, the pixel of position P_{B} and the neighborhood pixels form a pixel group arranged in a 5×5 matrix form and the pixel position of each pixel of the formed pixel group is represented by (i_{B}+p, i_{B}+q), the pixel of position P_{C} and the neighborhood pixels form a pixel group arranged in a 5×5 matrix form and the pixel position of each pixel of the formed pixel group is represented by (i_{C}+p, j_{C}+q), and the pixel of position P_{D} and the neighborhood pixels form a pixel group arranged in a 5×5 matrix form and the pixel position of each pixel of the formed pixel group is represented by (i_{D}+p, i_{D}+q).

Here, similar to the position P_{A}, P and q are integers and an inequality, −2≦p≦2 and −2≦q≦2 is established. The pixel position moves from up to down as p increases from −2 to 2 with center at the position P_{B}, (or P_{C}, or P_{D}), and the pixel position moves from left to right as q increases from −2 to 2 with center at the position P_{B}, (or P_{C}, or P_{D}). Then, the accumulated correlation value corresponding to each of the pixel positions (i_{B}+p, i_{B}+q), (i_{C}+p, j_{C}+q) and (i_{D}+p, i_{D}+q) is represented by each of V (i_{B}+p, j_{B}+q), V (i_{C}+p, i_{C}+q) and V (i_{D}+p, j_{D}+q).

The arithmetic circuit 55 further calculates and outputs a Nf number of candidate minimum correlation values for each of the detection regions E₁ to E₉. In the case of the present example, Nf is 4 with respect to each of the detection regions E₁ to E₉. In the following explanation, for each of detection region E₁ to E₉, data are calculated and output by arithmetic circuit 55. Data specifying “the candidate minimum correlation value V_{A}, the position P_{A} and the neighborhood accumulated correlation value V (i_{A}+p, j_{A}+q)” generally are termed “first candidate data.” Data specifying “the candidate minimum correlation value V_{B}, the position P_{B} and the neighborhood accumulated correlation value V (i_{B}+p, j_{B}+q)” generally are termed “second candidate data.” Data specifying “the candidate minimum correlation value V_{C}, the position P_{C} and the neighborhood accumulated correlation value V (i_{C}+p, i_{C}+q)” generally are termed “third candidate data.” Data specifying “the candidate minimum correlation value V_{D}, the position P_{D} and the neighborhood accumulated correlation value V (i_{D}+p, i_{D}+q)” generally are termed “fourth candidate data.”

### 2. Operation Flow of Displacement Detection Circuit

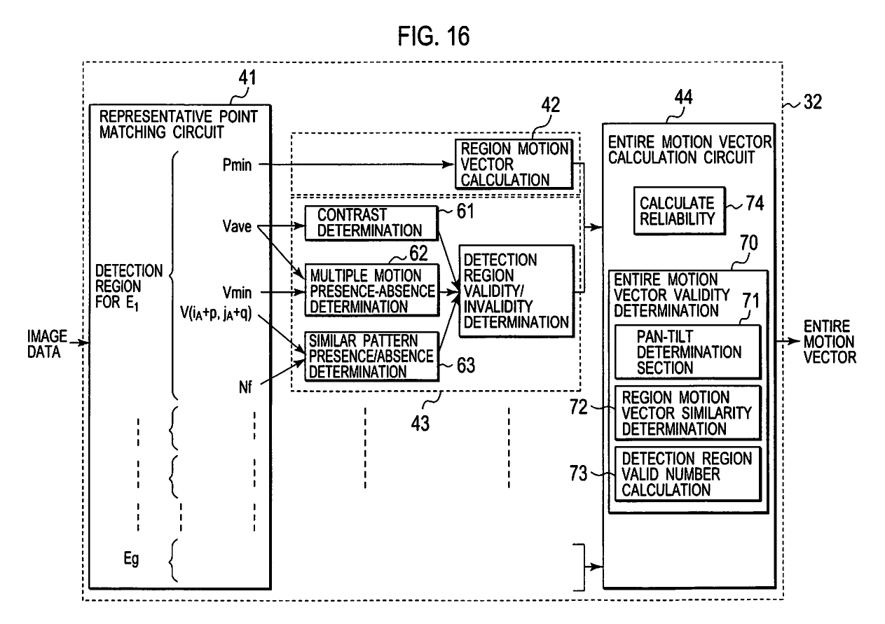

An explanation is next given of processing procedures of the displacement detection circuit 32 with reference to flowcharts in FIGS. 12 and 13. FIG. 16 illustrates a specific internal block diagram of displacement detection circuit 32 and the flow of each datum of the interior of displacement detection circuit 32. As illustrated in FIG. 16, detection region validity determination circuit 43 includes a contrast determination unit 61, a multiple motion presence-absence determination unit 62 and a similar pattern presence/absence determination unit 63. The entire motion vector calculation circuit 44 includes an entire motion vector validity determination unit 70. Furthermore, the entire motion vector validity determination unit 70 includes a pan-tilt determination unit 71, a region motion vector similarity determination unit 72 and a detection region valid number calculation unit 73.

By way of schematic explanation, displacement detection circuit 32 specifies a correlation value as an adopted minimum correlation value Pmin that corresponds to the real matching position from the candidate minimum correlation values for each detection region. Displacement detection circuit 32 sets a shift from a position of the representative position R to a position (P_{A}, P_{B}, P_{C} or P_{D} indicating an adopted minimum correlation value Vmin, which assumedly is a motion vector of the corresponding detection region. The motion vector of the detection region is hereinafter referred to as “region motion vector.” Then, an average of each region motion vector is output as an entire motion vector of an image (hereinafter referred to as “entire motion vector.)

Note that when the entire motion vector is calculated by averaging, validity or invalidity of the respective detection regions is estimated and the region motion vector corresponding to an invalid detection region is determined as invalid and excluded. Then, the average vector of the valid region motion vector is calculated as the entire motion vector in principle and an estimate of validity or invalidity is made for the calculated entire motion.

Note that processing in steps S12 to S18, as illustrated in FIG. 12 is executed by representative point matching circuit 41 in FIG. 5. Processing in step S24 is executed by region motion vector calculation circuit 42 in FIG. 5. Processing in steps S21 to S23, S25 and S26 is executed by detection region validity determination circuit 43 in FIG. 5. Processing in steps S41 to S49 illustrated in FIG. 13 is executed by the entire motion vector calculation circuit 44 in FIG. 5.

First, suppose that a variable k for specifying any one of nine detection regions E₁ to E₉ is set to 1 (step S11). Note that in the case of k=1, 2, . . . 9, processing of the detection regions E₁, E₂, . . . E₉ are carried out, respectively. Afterthat, accumulated correlation values of detection region Eₖ are calculated (step S12) and an average value Vave of accumulated correlation values of detection region Eₖ is calculated (step S13).

Then, candidate minimum correlation values are specified as candidates of the accumulated correlation value, which corresponds to the real matching position (step S14). At this time, it is assumed that four candidate minimum correlation values V_{A}, V_{B}, V_{C} and V_{D} are specified as candidate minimum correlation values as mentioned above. Then, “position and neighborhood accumulated correlation value” corresponding to each candidate minimum correlation value specified in step S14 are detected (step S15). Further, in step S14, the Nf number of candidate minimum correlation values specified in step S14 are calculated (step S16). By processing in steps S11 to S16, “average value Vave and first to fourth candidate data, and the number Nf” are calculated for the detection region Eₖ as shown in FIG. 11.

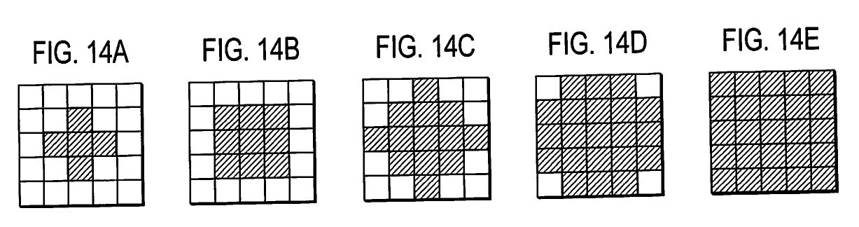

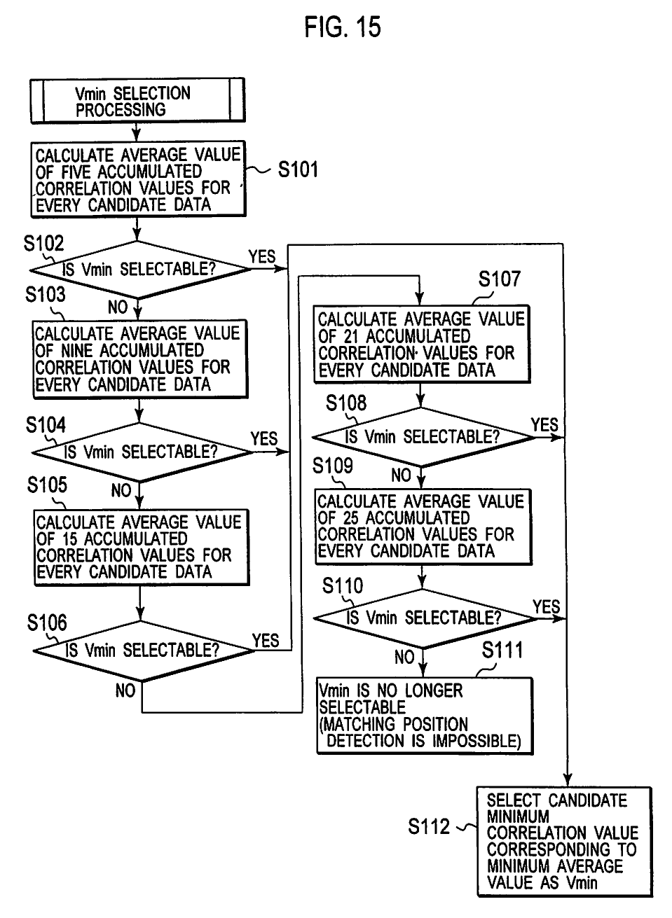

Then, a correlation value corresponding to the real matching position is selected as an adopted minimum correlation value Vmin from the candidate minimum correlation values with regard to the detection region Eₖ (step S17). Processing in step S17 will be specifically explained with reference to FIGS. 14 and 15.

In FIGS. 14A to 14E, the corresponding pixels for processing in step S17 are illustrated by oblique lines. FIG. 15 is a flowchart in which processing in step S17 is divided into several steps. Step S17 is composed of steps S101 to S112 as illustrated in the flowchart in FIG. 5.

When processing proceeds to step S17 as mentioned above, an average value (evaluation value for selection) of “a candidate minimum correlation value and four neighborhood accumulated correlation values” such that correspond to a pattern in FIG. 14A is first calculated with respect to each of the first to fourth candidate data (namely, every candidate minimum correlation value) (step S101). Namely, when (p, q) =(0, −1), (−1, 0), (0, 1), (1, 0), (0, 0), an average value V_{A}_ave of “accumulated correlation value V (i_{A}+p, j_{A}+q), an average value V_{B}_ave of “accumulated correlationvalue V (i_{B}+p, j_{B}+q), an average value V_{C}_ave of “accumulated correlation value V (i_{C}+p, j_{C}+q) and an average value V_{D}_ave of “accumulated correlation value V (i_{D}+p, j_{D}+q) are calculated.

Then, it is determined whether an adopted minimum correlation value Vmin can be selected on the basis of the average values calculated in step S101 (step S102). More specifically, among four average values calculated in step S101, when a difference between the minimum average value and each of other average values is less than a predetermined differential threshold value (for example, 2), it is determined that no adopted minimum correlation value Vmin can be selected (no reliability in selection) and processing proceeds to step S103, otherwise, processing proceeds to step S112 and a candidate minimum correlation value corresponding to the minimum average value is selected as the adopted minimum correlation value Vmin from among four average values calculated in step S101. For example, when an inequality, V_{A}_ave<V_{B}_ave <V_{C}_ave<V_{D}_ave, is established, the minimum correlation value V_{A} is selected as adopted minimum correlation value Vmin. After that, the same processing as that in steps S101 and S102 is performed as a changed position of the accumulated correlation value and the number to be referenced when the adopted minimum correlation value Vmin is selected.

Namely, when processing proceeds to step S103, average values of “a candidate minimum correlation value and eight neighborhood accumulated correlation values” such that correspond to a pattern in FIG. 14B are calculated with respect to each of the first to fourth candidate data (namely, every candidate minimum correlation value). In other words, when (p, q)=(−1, −1), (−1, 0), (−1, 1), (0, −1), (0, 0), (0, 1), (1, −1), (1, 0), (1, 1), an average value V_{A}_ave of “accumulated correlation value V (i_{A}+p, j_{A}+q), an average value V_{B}_ave of “accumulated correlation value V (i_{B}+p, j_{B}+q), an average value V_{C}_ave of “accumulated correlation value V (i_{C}+p, j_{C}+q) and an average value V_{D}_ave of “accumulated correlation value V (i_{D}+p, j_{D}+q) are calculated.

Then, it is determined whether an adopted minimum correlation value Vmin can be selected on the basis of the average values calculated in step S103 (step S104). More specifically, among four average values calculated in step S103, when a difference between the minimum average value and each of other average values is less than a predetermined differential threshold value (for example, 2), it is determined that no adopted minimum correlation value Vmin can be selected (no reliability in selection) and processing proceeds to step S105. Otherwise, processing proceeds to step S112 and the candidate minimum correlation value corresponding to the minimum average value is selected as the adopted minimum correlation value Vmin from among four average values calculated in step S103.

In step S105, average values of “a candidate minimum correlation value and 12 neighborhood accumulated correlation values” such that correspond to a pattern in FIG. 14C are calculated with respect to each of the first to fourth candidate data (namely, every candidate minimum correlation value). In other words, when (p, q)=(−1, −1), (−1, 0), (−1, 1), (0, −1), (0, 0), (0, 1), (1, −1), (1, 0), (1, 1), (−2, 0), (2, 0), (0, 2), (0, −2), an average value V_{A}_ave of “accumulated correlation value V (i_{A}+p, j_{A}+q), an average value V_{B}_ave of “accumulated correlation value V (i_{B}+p, j_{B}+q), an average value V_{C}_ave of “accumulated correlation value V (i_{C}+p, j_{C}+q) and an average value V_{D}_ave of “accumulated correlation value V (i_{D}+p, j_{D}+q) are calculated.

Then, it is determined whether an adopted minimum correlation value Vmin can be selected on the basis of the average values calculated in step S105 (step S106). More specifically, among four average values calculated in step S105, when a difference between the minimum average value and each of other average values is less than a predetermined differential threshold value (for example, 2), it is determined that no adopted minimum correlation value Vmin can be selected (no reliability in selection) and processing proceeds to step S107. Otherwise, processing proceeds to step S112 and the candidate minimum correlation value corresponding to the minimum average value is selected as the adopted minimum correlation value Vmin from among four average values calculated in step S105.

In step S107, average values of “a candidate minimum correlation value and 20 neighborhood accumulated correlation values” such that correspond to a pattern in FIG. 14D is calculated with respect to each of the first to fourth candidate data (namely, every candidate minimum correlation value). In other words, when (p, q)=(−2, −1), (−2, 0), (−2, 1), (−1, −2), (−1, −1), (−1, 0), (−1, 1), (−1, 2), (0, ‘2), (0, −1), (0, 0), (0, 1), (0, 2), (1, −2), (1, −1), (1, 0), (1, 1), (1, 2), (2, −1), (2, 0), (2, 1), an average value V_{A}_ave of “accumulated correlation value V (i_{A}+p, j_{A}+q), an average value V_{B}_ave of “accumulated correlation value V (i_{B}+p, j_{B}+q), an average value V_{C}_ave of “accumulated correlation value V (i_{C}+p, j_{C}+q) and an average value V_{D}_ave of “accumulated correlation value V (i_{D}+p, j_{D}+q) are calculated.

Then, it is determined whether an adopted minimum correlation value Vmin can be selected on the basis of average values calculated in step S107 (step S108). More specifically, among four average values calculated in step S107, when a difference between the minimum average value and each of other average values is less than a predetermined differential threshold value (for example, 2), no adopted minimum correlation value Vmin can be selected (no reliability in selection) and processing proceeds to step S109. Otherwise, processing proceeds to step S112 and the candidate minimum correlation value corresponding to the minimum average value is selected as the adopted minimum correlation value Vmin from among four average values calculated in step S107.

In step S109, average values of “a candidate minimum correlation value and 24 neighborhood accumulated correlation values” such as that correspond to a pattern in FIG. 14E are calculated with respect to each of the first to fourth candidate data (namely, every candidate minimum correlation value). In other words, when (p, q)=(−2, −2), (−2, −1), (−2, 0), (−2, 1), (−2, 2), (−1, −2), (−1, ‘1), (−1, 0), (−1, 1), (−1, 2), (0, −2), (0, −1), (0, 0), (0, 1), (0, 2), (1, −2), (1, −1), (1, 0), (1, 1), (1, 2), (2, −2), (2, −1), (2, 0), (2, 1), (2, 2), an average value V_{A}_ave of “accumulated correlation value V (i_{A}+p, j_{A}+q), an average value V_{B}_ave of “accumulated correlation value V (i_{B}+p, j_{B}+q), an average value V_{C}_ave of “accumulated correlation value V (i_{C}+p, j_{C}+q) and an average value V_{D}_ave of “accumulated correlation value V (i_{D}+p, j_{D}+q) are calculated.

Then, it is determined whether an adopted minimum correlation value Vmin can be selected based on the average values calculated in step S109 (step S110). More specifically, among four average values calculated in step S109, when a difference between the minimum average value and each of other average values is less than a predetermined differential threshold value (for example, 2), it is determined that no adopted minimum correlation value Vmin can be selected (no reliability in selection) and processing proceeds to step S111. Otherwise, processing proceeds to step S112 and the candidate minimum correlation value corresponding to the minimum average value is selected as the adopted minimum correlation value Vmin from among four average values calculated in step S109.

In the case where processing proceeds to step S111, it is finally determined that the adopted minimum correlation value Vmin is no longer selected. In other words, it is determined that the matching position cannot be selected. Incidentally, although the above explanation has been given of the case in which the number of candidate minimum correlation values is two or more, when the number of candidate minimum correlation values is only one, one candidate minimum correlation value is directly used as the adopted minimum correlation value Vmin.

On the basis of operation according to the flowchart in FIG. 15, when the adopted minimum correlation value Vmin is selected in step S17, the position Pmin of the pixel, which indicates the adopted minimum correlation value Vmin is specified (step S18). For example, when the candidate minimum correlation value V_{A} is selected as the adopted minimum correlation Vmin, the position P_{A} corresponds to the position Pmin. When the adopted minimum correlation value Vmin and the position Pmin are specified in steps S17 and S18, processing proceeds to step S21. Then, in steps S21 to S26, it is determined that the detection area Eₖ is valid or invalid and the region motion vector Mₖ of the detection region Eₖ is calculated. The content of processing in each step will be specifically explained.

First, the similar pattern presence/absence determination unit 63 (see FIG. 16) determines whether or not a similar pattern is present in the detection region Eₖ (step S21). At this time, when the similar pattern is present, reliability of the region motion vector calculated with respect to the corresponding detection region Eₖ is low. That is, the region motion vector Mₖ does not precisely express the motion of the image in the detection region Eₖ. Accordingly, in this case, it is determined that the detection region Eₖ is invalid (step S26). Determination in step S21 is executed on the basis of the processing result in step S17.

Namely, when the adopted minimum correlation value Vmin is selected after processing reaches step S112 in FIG. 15, it is determined that the similar pattern is absent and processing proceeds to step S22 from step S21. On the other hand, when the adopted minimum correlation value Vmin is not selected after processing reaches step S111 in FIG. 15, it is determined that the similar pattern is present and processing proceeds to step S26 from step S21.

When processing proceeds to step S22, the contrast determination unit 61 (see FIG. 16) determines whether contrast of the image in the detection region Eₖ is low. When the contrast is low, it is difficult to correctly detect the region motion vector, and therefore the detection region Eₖ is made invalid. More specifically, it is determined whether the average value Vave of the accumulated correlation values is less than a predetermined threshold value TH. Then, when an inequality “Vave ≦TH1” is established, it is determined that the contrast is low, processing proceeds to step S26, and the detection region Eₖ is made invalid.

This determination is on the basis of the principle in which when the contrast of the image low (for example, the entirety of the image is white), the luminance difference is small, and therefore the accumulated correlation value becomes small as a whole. On the other hand, when the inequality “Vave≦TH1” is not met, it is not determined that the contrast is low, and processing proceeds to step S23. In addition, the threshold value TH1 is set to an appropriate value by experiment.

When processing proceeds to step S23, the multiple motion presence-absence determination unit 62 (see FIG. 16) determines whether multiple motions are present in the detection region Eₖ. When there is an object that proceeds regardless of camera shake in the detection region Eₖ, it is determined that the multiple motions are present in the detection region Eₖ. When the multiple motions are present, it is difficult to correctly detect the region motion vector, and therefore the detection region Eₖ is made invalid.

More specifically, it is determined whether an inequality “Vave/Vmin≦TH2” is met. When the inequality is formed, it is determined that the multiple motions are present, processing proceeds to step S26 and the detection region Eₖ is made invalid. This determination is on the basis of the principle in which when multiple motions are present, there is no complete matching position, and therefore the minimum value of the accumulated correlation value becomes large. Furthermore, division of the average value Vave prevents this determination from depending on the contrast of the subject. On the other hand, when the inequality “Vave/Vmin≦TH2” is not established, it is determined that the multiple motions are absent, processing proceeds to step S24. In addition, the threshold value TH2 is set to an appropriate value by experiment.

When processing proceeds to step S24, the region motion vector calculation circuit 42 illustrated in FIG. 5 (FIG. 16) calculates a region motion vector Mₖ from the position Pmin indicating the real matching position. For example, when the position PA corresponds to the position Pmin, the region motion vector calculation circuit 42 calculates a region motion vector Mₖ from position information that specifies the position P_{A} on the image (information that specifies the pixelposition (i_{A}, j_{A}). More specifically, the direction and magnitude of shift from the position of the representative position R to the position Pmin (P_{A}, P_{B}, P_{C}, or P_{D}) indicating an adopted minimum correlation value Vmin are assumed to be the same as those of the region motion vector Mₖ.

Next, the detection region Eₖ is made valid (step S25) and processing proceeds to step S31. On the other hand, in step S26 where processing may move from steps S21 to S23, the detection region Eₖ is made invalid as mentioned above and processing proceeds to step S311. In step S31, 1 is added to a variable k and it is determined whether the variable k obtained by adding 1 is greater than 9 (step S32). At this time, when an inequality “k>9” is not established, processing returns to step S12 and processing in step S12 and other steps are repeated with respect to the other detection region. On the contrary, when an inequality “k>9” is established, this means that processing in step S12 and other steps have been performed with respect to all of the detection regions E₁ to E₉, and therefore processing proceeds to step S41 in FIG. 13.

In steps S41 to S49 in FIG. 13, calculation processing and validity determination processing for the entire motion vector M are carried out on the basis of the region motion vector Mₖ (1≦k≦9).

First, it is determined whether the number of detection regions determined as validity (hereinafter referred to as “valid region”) is 0 according to the processing result in steps S25 and S26 in FIG. 12. When one or more valid regions are present, the region motion vectors Mₖ in the valid regions are extracted (step S42) and the extracted region motion vectors Mₖ of the valid regions are averaged to thereby calculate an average vector Mave of these vectors (step S43).

Then, the region motion vector similarity determination unit 72 (see FIG. 16) determines similarity of the region motion vectors Mₖ of the valid regions (step S44). In other words, a variation A of region motion vector Mk between the valid regions is estimated to thereby determine whether an object having a different motion is present between the valid regions. Specifically, the variation A is calculated on the basis of the following equation (1). Then, it is determined whether the variation A is more than the threshold value TH3. Note that in the equation (1), a [sum total of {|Mₖ−Mave|/(Norm of Mave)}9 corresponds to a value obtained by adding up values of {|Mₖ−Mave|/(Norm of Mave) } of all valid regions, each calculated for each valid region. Furthermore, the detection region validity calculation unit 73 illustrated in FIG. 16 calculates the number of valid regions.

A=[Sum total of {|Mₖ−Mave|/(Norm of Mave)}]/(Number of valid region) (1)

As a result of the determination result in step S44, when the variation A is less than threshold TH3, the motion vector of the entire image (entire motion vector) M is used as the average vector Mave calculated in step S43 (step S45), and processing proceeds to step S47. On the contrary, when the variation A is more than the threshold TH3, similarity of the region motion vector of the valid region is low and reliability of the entire motion vector on the basis of this is low. For this reason, when the variation A is more than the threshold TH3, the entire motion vector M is set to 0 (step S46) and processing proceeds to step S47. Furthermore, even when it is determined that the number of valid regions is 0 in step S41, the entire motion vector M is 0 in step S46 and processing proceeds to step S47.

When processing proceeds to step S47, the entire motion vector M currently obtained is added to history data Mn of the entire motion vector. As mentioned above, each processing illustrated in FIGS. 12 and 13 is sequentially carried out in the wide dynamic range imaging mode regardless of whether shutter button 21 is pressed. The entire motion vectors M obtained in steps S45 and S46 sequentially are stored in the history data Mn of the entire motion vector. Note that when the entire motion vectors M of the reference image data and non-reference image data are obtained upon one press of shutter button 21, the result is added to the history data Mn in pan-tilt determination processing to be described later.

Then, pan-tilt determination unit 73 (see FIG. 16) determines whether the imaging apparatus is in a pan-tilt state on the basis of the history data Mn (step S48). The “pan-tilt state” means that the imaging apparatus is panned or tilted. The word “pan (panning)” means a cabinet (not shown) of the imaging apparatus is moved in left and right directions and the word “tilt (tilting)” means that the cabinet of the imagining apparatus is moved in up and down directions. As a method for determining whether the imaging apparatus is panned or tilted, there may be used a method described in Japanese Patent Application No. 2006-91285 proposed by the present applicant.

For example, when the following first or second condition is satisfied, it is determined that transition from “camera shake state” to “pan-tilt state” has occurred (“camera shake” is not included in the “pan-tilt state”). Note that the first condition is that “the entire motion vector M continuously points in the same direction, which is a vertical direction (upward and downward directions) or horizontal direction (right and left directions), the predetermined number of times or more” and the second condition is that “an integrated value of magnitude of the entire motion vector M continuously pointing in the same direction is a fixed ratio of a field angle of the imaging apparatus or more.”

Then, for example, when the following third or fourth condition is satisfied, it is determined that transition from “pan-tilt state” to “camera shake state” has occurred. Note that the third condition is that “a state continues the predetermined times (for example, 10 times) where magnitude of the entire motion vector is less than 0.5 pixel or less and the fourth condition is that “an entire motion vector M, in a direction opposite to an entire motion vector M when transition from “camera shake state” to “pan-tilt state” occurs, is continuously obtained the predetermined number of times (for example, 10 times) or more.”

Establishment/non-establishment of the first to fourth conditions is determined on the basis of the entire motion vector M currently obtained and the past entire motion vector M both stored in the history data Mn. The determination result of whether or not the imaging apparatus is in the “pan-tilt state” is transmitted to microcomputer 10. After that, the entire motion vector validity determination unit 70 (see FIG. 13) determines whether or not the entire motion vector M currently obtained is valid on the basis of the processing result in steps S41 to S48 (step S49).

More specifically, “when processing reaches step S46 after determining that the number of valid regions is 0 in step S42” or “when processing reaches step S46 after determining that similarity of the region motion vectors Mₖ of the valid regions is low in step S44” or “when it is determined that the imaging apparatus is in the pan-tilt state in step S48”, the entire motion vector M currently obtained is made invalid, otherwise the entire motion vector M currently obtained is made valid. Moreover, at the time of panning or tilting, the amount of camera shake is large and the shift between the images to be compared exceeds the motion detection range according to the size of the small region e, and therefore it is impossible to correctly detect the vector. For this reason, when it is determined that the imaging apparatus is in the pan-tilt state, the entire motion vector M is made invalid.

Thus, when shutter button 21 is pressed in the wide dynamic range imaging mode, the entire motion vector M thus obtained and information that specifies whether the entire motion vector M is valid or invalid are transmitted to displacement correction circuit 33 in FIG. 1.

### (Displacement Correction Circuit)

When shutter button 21 is pressed, the entire motion vector M and information that specifies validity of the entire motion vector M obtained by displacement detection circuit 32 are transmitted to displacement correction circuit 33. Then, displacement correction circuit 33 checks whether the entire motion vector M is valid or invalid on the basis of information that specifies the given validity, and performs displacement correction on non-reference image data.

When displacement detection circuit 32 determines that the entire motion vector M between the reference image data and the non-reference image data, which has been obtained by pressing shutter button 21, is valid, displacement correction circuit 33 changes a coordinate position of the non-reference image data read from image memory 5 on the basis of the entire motion vector M transmitted from the displacement detection circuit 32 and performs displacement correction such that the reference image data and the coordinate position match with each other. Then, the non-reference image data subjected to displacement correction is transmitted to image synthesizing circuit 34.

On the other hand, when displacement detection circuit 32 determines that the entire motion vector M is invalid, the non-reference image data read from image memory 5 is directly transmitted to image synthesizing circuit 34 without being subjected to the displacement correction by displacement correction circuit 33. Namely, displacement detection circuit 32 sets the entire motion vector M zero between the reference image data and the non-reference image data and performs displacement correction on the non-reference image data and supplies the result to image synthesizing circuit 34.

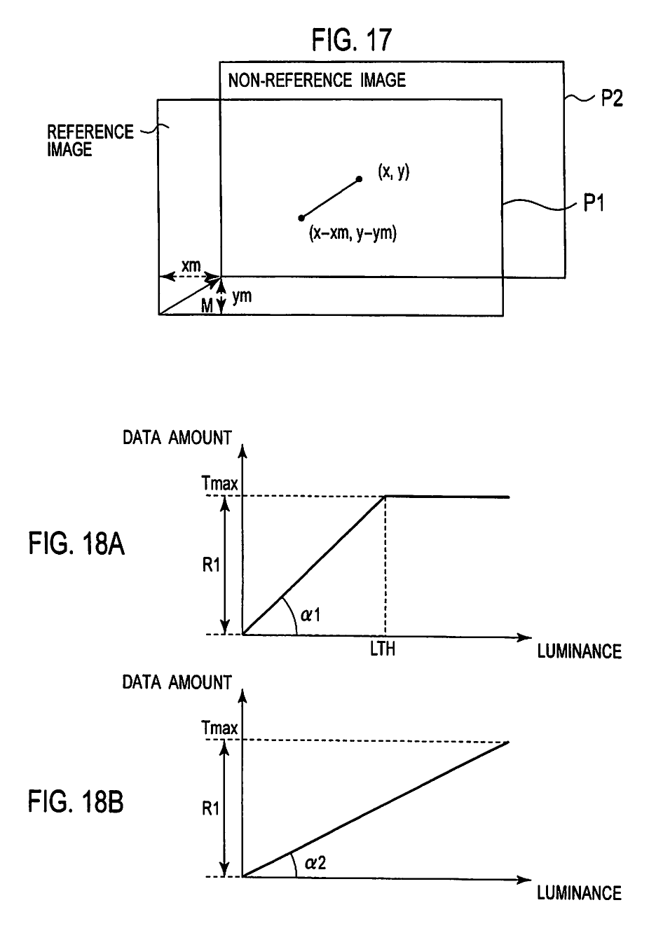

For example, when the entire motion vector M between the reference image data and the non-reference image data is valid and the entire motion vector M is placed at a position (xm, ym) as illustrated in FIG. 17, a pixel position (x, y) of a non-reference image P2 is made to match with a pixel position (x-xm, y-ym) of a reference pixel P1 by displacement correction circuit 33. Namely, the non-reference image data are changed such that the luminance value of the pixel position (x, y) of the non-reference image data is the same as that of the pixel position (x-xm, y-ym), whereby displacement correction is performed. In this way, the non-reference image data subjected to displacement correction are transmitted to image synthesizing circuit 34.

### (Image Synthesizing Circuit)

When shutter button 21 is pressed, the reference image data read from image memory 5 and the non-reference image data subjected to displacement correction by displacement correction circuit 33 are transmitted to image synthesizing circuit 34. Then, the luminance value of the reference image data and that of the non-reference image data are synthesized for each pixel position, so that image data (synthesized image data), serving as a synthesized image, is generated on the basis of the synthesized luminance value.

First, the reference image data transmitted from the image memory 5 has a relationship between a luminance value and data amount as shown in FIG. 18A, that is, the data value has a proportional relationship with the luminance value in the case of the luminance value lower than luminance value Lth and the data value reaches a saturation level Tmax in case of the luminance value higher than the luminance value Lth. Then, the non-reference image data transmitted from displacement correction circuit 33 has a relationship between a luminance value and data amount as shown in FIG. 18B. That is, the data value has a proportional relationship with the luminance value and a proportional inclination α2 is smaller than an inclination al in the reference image data.

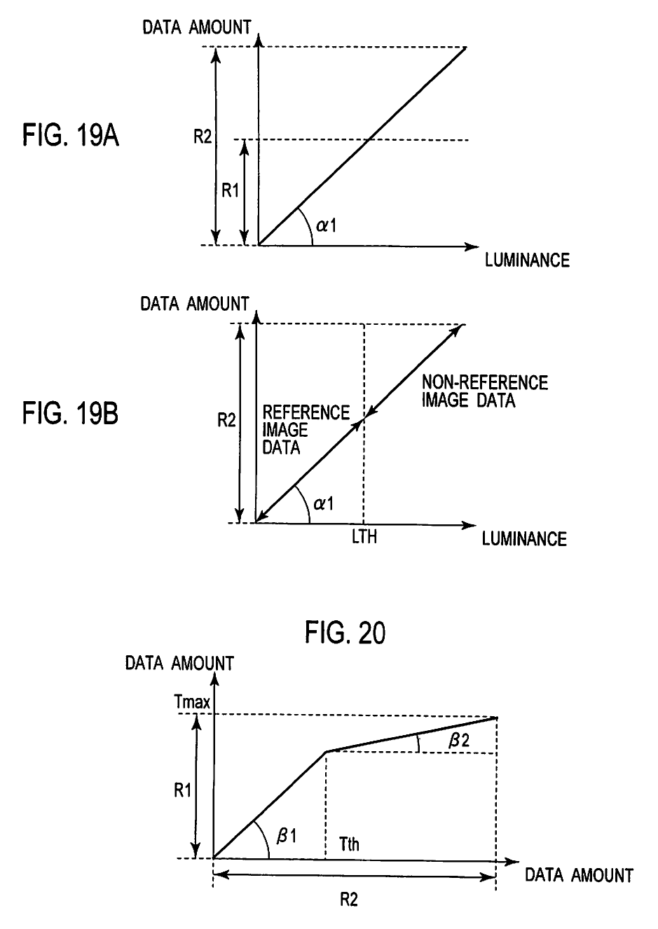

At this time, the data value of each pixel position of the non-reference image data is amplified by α1/α2 such that the inclination α2 of data value to the luminance value in the non-reference image data having the relationship as shown in FIG. 18B is the same as the inclination α1 in the reference image data having the relationship as shown in FIG. 18A. By this means, as shown in FIG. 19A, the inclination α2 of data value to the luminance value in the non-reference image data as shown in FIG. 18B is changed to the inclination α1 and the dynamic range of the non-reference image data expands from R1 to R2 (=R1×α1/α2).

Then, the data value of the reference image data is used for the pixel position where the data value (luminance value which is less than the luminance value Lth) is less than the data value Tmax in the non-reference image data, and the data value of the non-reference image data is used for the pixel position where the data value (luminance value larger than the luminance value Lth) is larger the data value Tmax in the non-reference image data. As a result, there can be obtained synthesized image data where the reference image data and the non-reference image data are synthesized on the basis of the relationship between the luminance value Lth and the dynamic range is R2.

Then, the dynamic range R2 is compressed to the original dynamic range R1. At this time, compression transformation is performed on the synthesized image data as illustrated in FIG. 19B on the basis of transformation such that an inclination β1 between pre-transformation and post-transformation, where the data value is less than Tth, is larger than an inclination β2 between pre-transformation and post-transformation, where the data value is larger than Tth. The compression transformation is thus performed to thereby generate the synthesized image data having the same dynamic range as those of the reference image data and the non-reference image data.

Then, the synthesized image data obtained by synthesizing the reference image data and the non-image data by the image combing circuit 34 is stored in image memory 35. The synthesized image composed of the synthesized image data stored in image memory 35 represents a still image taken upon the press of shutter button 21. When this synthesized image data, serving as a still image, is transmitted to NTSC encoder 6 from image memory 35, the synthesized image is reproduced and displayed on monitor 7. Moreover, when the synthesized image data is transmitted to image compression circuit 8 from image memory 35, the synthesized image data is compression-coded by image compression circuit 8 and the result is stored in memory card 9.

### (Operation Flow of Wide Dynamic Range Imaging Mode)

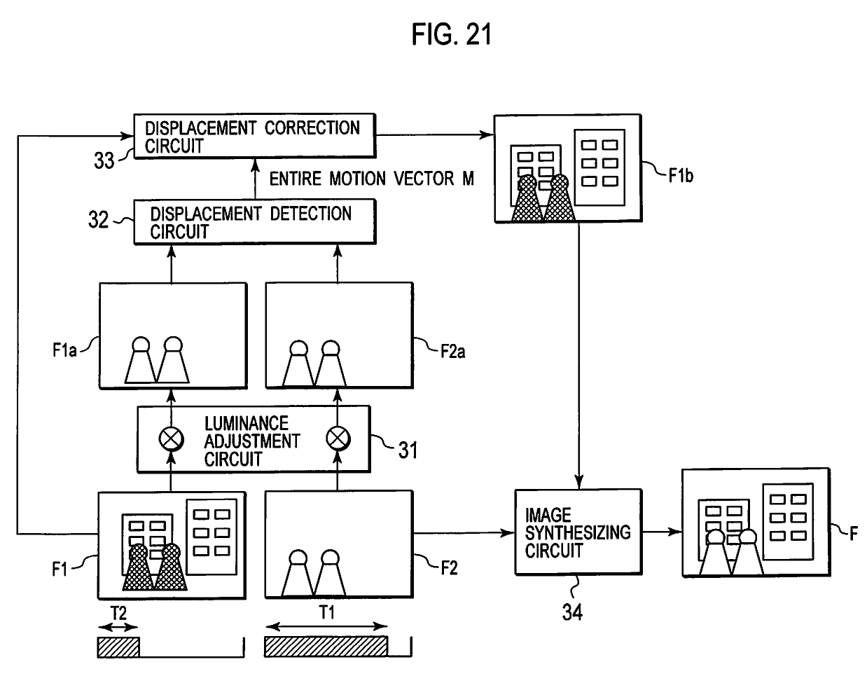

With reference to FIG. 21, an explanation will be given of operation flow of the entire apparatus when each block is operated in the wide dynamic range imaging mode, for example, shutter button 21 is pressed. FIG. 21 is a functional block diagram explaining the operation flow of the main components of the apparatus in the wide dynamic range imaging mode.

After non-reference image data F1 captured by imaging device 2 with exposure time T2 is transmitted and stored in image memory 5, reference image data F2 captured by imaging device 2 with exposure time T1 is transmitted and stored in image memory 5. Then, when the non-reference image data F1 and the reference image data F2 stored in image memory 5 are transmitted to luminance adjustment circuit 31, luminance adjustment circuit 31 amplifies each data value such that the average luminance value of the non-reference image data F1 and that of the reference image data F2 are equal to each other.

By this means, non-reference image data F1a having amplified data value of non-reference image data F1 and reference image data F2a having amplified data value of reference image data F2 are transmitted to displacement detection circuit 32. Displacement detection circuit 32 performs a comparison between the non-reference image data F1a and the reference image data F2a, each having an equal average luminance value, to thereby calculate the entire motion vector M, which indicates the displacement between the non-reference image data F1a and the reference image data F2a.

The entire motion vector M is transmitted to displacement correction circuit 33 and the non-reference image data F1 stored in image memory 5 is transmitted to displacement correction circuit 33. By this means, displacement correction circuit 33 performs displacement correction on the non-reference image data F1 on the basis of the entire motion vector M to thereby generate non-reference image data F1b.

The non-reference image data F1b subjected to displacement correction are transmitted to image synthesizing circuit 34 and the reference image data F2 stored in image memory 5 are also transmitted to image synthesizing circuit 34. Then, image synthesizing circuit 34 generates synthesized image data F having a wide dynamic range on the basis of the data value of each of the non-reference image data F1b and reference image data F2, and stores the synthesized image data F in image memory 35. As a result, the wide dynamic range image generation circuit 30 is operated to make it possible to obtain an image having a wide dynamic range where blackout in an image with a small amount of exposure and whiteout in an image having a large amount of exposure are eliminated.

Note that although the reference image data F2 are captured after the non-reference image data F1 are captured in this example of the operation flow, this may be performed in an inverse order. Namely, after reference image data F2 captured by imaging device 2 with exposure time T1 are transmitted and stored in image memory 5, non-reference image data F1 captured by imaging device 2 with exposure time T2 are transmitted and stored in image memory 5.

Furthermore, when the non-reference image data F1 and the reference image data F2 are captured for each frame, each imaging time may be different depending on exposure time or may be the same regardless of exposure time. When the imaging time per frame is the same regardless of exposure time, there is no need to change scanning timing such as horizontal scanning and vertical scanning, which allows a reduction in operation load on software and hardware. Moreover, when the imaging time changes according to exposure time, imaging time for the non-reference image data F1 can be shortened. Therefore it is possible to suppress displacement between frames when the non-reference image data F1 is captured after the reference image data F2 is captured.

According to this embodiment, image data of two frames, each having a different amount of exposure, is synthesized in the wide dynamic range image mode, so that positioning of image data of two frames to be synthesized is performed in generating a synthesized image having a wide dynamic range. At this time, after luminance adjustment is performed on image data of each frame such that the respective average luminance values substantially match with each other, displacement of image data is detected to perform displacement correction. Therefore, it is possible to prevent occurrence of blurring in a synthesized image and to obtain an image with high gradation and high accuracy.

### Second Embodiment

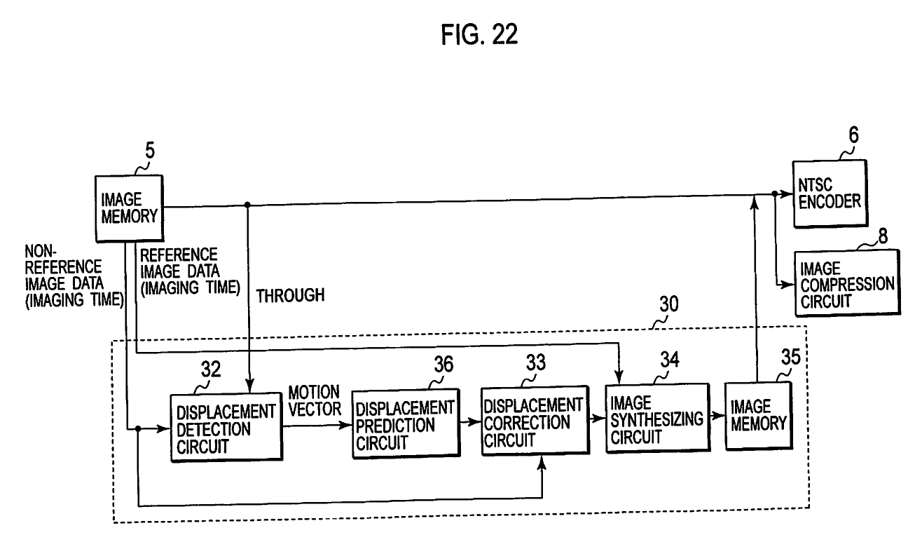

A second embodiment is explained with reference to the drawings. FIG. 22 is a block diagram illustrating an internal configuration of wide dynamic range image generation circuit 30 in the imaging apparatus of this embodiment. Note that the same parts in the configuration in FIG. 22 as those in FIG. 2 are assigned the same reference numerals as those in FIG. 2 and detailed explanations thereof are omitted.

Wide dynamic range image generation circuit 30 of the imaging apparatus of this embodiment has a configuration in which luminance adjustment circuit 31 is omitted from wide dynamic range image generation circuit 30 in FIG. 2 and a displacement prediction circuit 36, which predicts actual displacement from the displacement (motion vector) detected by displacement detection circuit 32, is added as shown in FIG. 22. In wide dynamic range image generation circuit 30 illustrated in FIG. 22, the operations of displacement detection circuit 32, displacement correction circuit 33 and image synthesizing circuit 34 are the same as those of the first embodiment, and therefore detailed explanations thereof are omitted.

First, in the imaging apparatus of this embodiment, in the condition that the wide dynamic range imaging mode is set by dynamic range change-over switching 22, when shutter button 21 is not pressed, the same operations are performed as those in the first embodiment. Namely, imaging device 2 performs imaging for a fixed period of time and an image, which is on the basis of the image data, is reproduced and displayed on monitor 7, and is also transmitted to wide dynamic range image generation circuit 30, and displacement detection circuit 32 calculates a motion vector between two frames that is used in processing (pan-tilt state determination processing) in step S48 in FIG. 13.

Moreover, in the condition that the wide dynamic range imaging mode is set, when shutter button 21 is pressed, imaging of three frames including two frames with long exposure time and one frame with short exposure time is performed by the imaging device and the result is stored in image memory 5. Then, regarding imaging of two frames with short exposure time, the exposure time is set to be the same value and the average luminance values of the images obtained by imaging are substantially equal to each other. In those operations, each of image data of two frames with short exposure time are non-reference image data and each of image data of one frame with long exposure time are reference image data.

Two non-reference image data are transmitted to displacement detection circuit 32 from image memory 5 to thereby detect the displacement (entire motion vector) between the images. After that, the displacement prediction circuit 36 predicts displacement (entire motion vector) between images of continuously captured non-reference image data and reference image data on the basis of a ratio between a time difference Ta between timing at which non-reference image data is captured and timing at which another non-reference image data is captured and a time difference Tb between timing at which non-reference image data are continuously captured and timing at which reference image data is captured.

When receiving the predicted displacement (entire motion vector) between the images, the displacement correction circuit 33 performs displacement correction on the non-reference image data continuous to the frame of the reference image data. Then, when the non-reference image data subjected to displacement correction by displacement correction circuit 33 is transmitted to image synthesizing circuit 34, the transmitted non-reference image data are synthesized with the reference image data transmitted from image memory 5 to generate synthesized image data. These synthesized image data are temporarily stored in image memory 35. When these synthesized image data, serving as a still image, are transmitted to NTSC encoder 6 from image memory 35, the synthesized image is reproduced and displayed on monitor 7. Moreover, when the synthesized image data are transmitted to image compression circuit 8 from image memory 35, the synthesized image data are compression-coded by image compression circuit 8 and the result is stored in memory card 9.

In the imaging apparatus thus operated, when receiving non-reference image data of two frames from image memory 5, displacement detection circuit 32 performs the operation according to the flowcharts in FIGS. 12 and 13 in the first embodiment to thereby calculate an entire motion vector and detect displacement. Moreover, when receiving the entire motion vector from displacement prediction circuit 36 and the non-reference image data from image memory 5, displacement correction circuit 33 performs the same displacement processing as that in the first embodiment. Furthermore, when receiving the reference image data and the non-reference image data from image memory 5 and displacement correction circuit 33, respectively, image synthesizing circuit 34 performs the same image synthesizing processing as that in the first embodiment (see FIGS. 18 to 20). Therefore, the operation flow in the wide dynamic range imaging mode in this embodiment will be explained as follows.

### (First Example of Operation Flow in Wide Dynamic Range Imaging Mode)

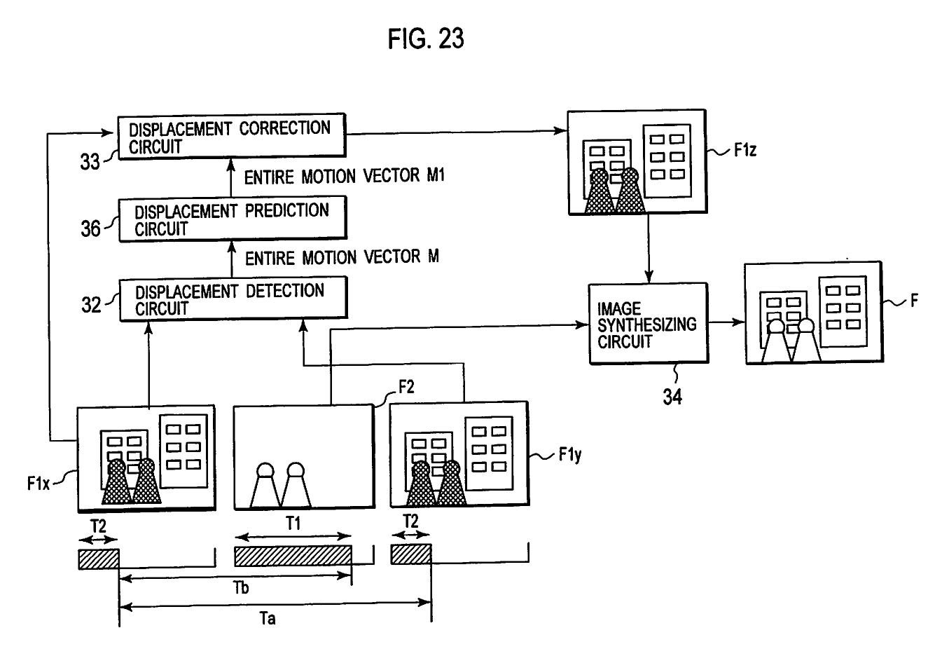

The following will explain a first example of the operation flow of the entire apparatus when shutter button 21 is pressed in wide dynamic range imaging mode with reference to FIG. 23. In this example, imaging is performed in order of non-reference image data, reference image data and non-reference image data.

After non-reference image data F1x captured by imaging device 2 with exposure time T2 are transmitted and stored in image memory 5, reference image data F2 captured by imaging device 2 with exposure time T1 are transmitted and stored in image memory 5. After that, non-reference image data Fly captured by imaging device 2 with exposure time T2 are further transmitted and stored in image memory 5. Then, when receiving the non-reference image data F1x and F1y stored in image memory 5, displacement detection circuit 32 performs a comparison between the non-reference image data F1x and F1y to thereby calculate an entire motion vector M indicating an amount of displacement between the non-reference image data F1x and F1y.

This entire motion vector M is transmitted to displacement prediction circuit 36. It is assumed in displacement prediction circuit 36 that displacement corresponding to the entire motion vector M is generated by imaging device 2 between a time difference Ta between timing at which non-reference image data F1x are read and timing at which non-reference image data F1y are read and an amount of displacement is proportional to time. Accordingly, in displacement prediction circuit 36, on the basis of the time difference Ta between timing at which non-reference image data F1x is read and timing at which non-reference image data F1y is read, the time difference Tb between timing at which non-reference image data F1x is read and timing at which reference image data F2 is read and the entire motion vector M indicating an amount of displacement between the non-reference image data F1x and F1y, an entire motion vector M1, which indicates an amount of displacement between the non-reference image data F1x and the reference image data F2, is calculated as: M×Tb/Ta.

The entire motion vector M1 thus obtained by displacement prediction circuit 36 is transmitted to displacement correction circuit 33 and the non-reference image data F1x stored in image memory 5 is also transmitted to displacement correction circuit 33. By this means, displacement correction circuit 33 performs displacement correction the non-reference image data F1x on the basis of the entire motion vector M1, thereby generating non-reference image data F1z.

The non-reference image data F1z subjected to displacement correction is transmitted to image synthesizing circuit 34 and the reference image data F2 stored in image memory 5 is also transmitted to image synthesizing circuit 34. Then, image synthesizing circuit 34 generates synthesized image data F having a wide dynamic range on the basis of the data values for each of the non-reference image data F1z and the reference image data F2, and stores the synthesized image data F in image memory 35. As a result, wide dynamic range image generation circuit 30 is operated to make it possible to obtain an image having a wide dynamic range where blackout in an image with a small amount of exposure and whiteout in an image having a large amount of exposure are eliminated.

### (Second Example of Operation Flow in Wide Dynamic Range Imaging Mode)

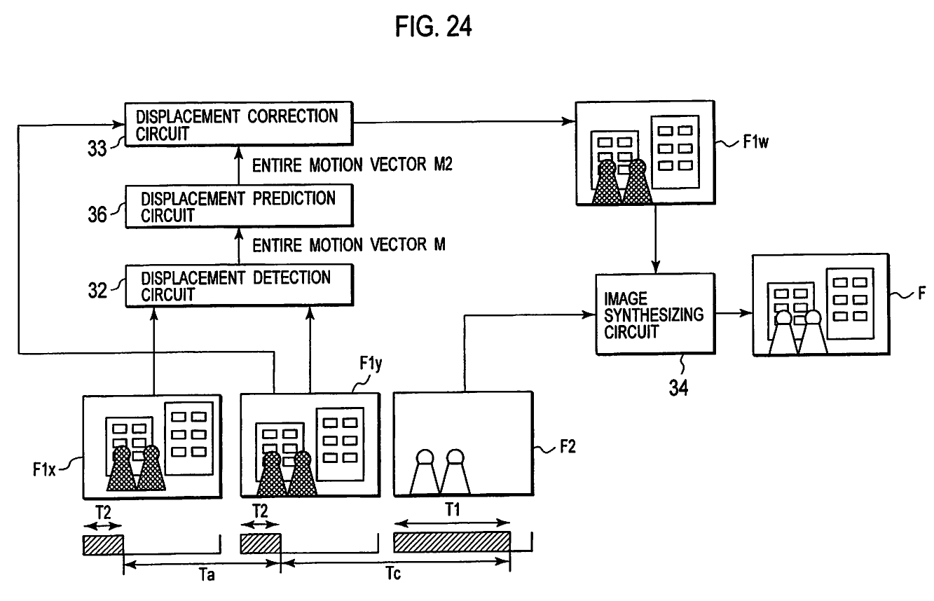

Moreover, the following will explain a second example of the operation flow of the entire apparatus when shutter button 21 is pressed in wide dynamic range imaging mode with reference to FIG. 24. In this example, imaging is performed in order of non-reference image data, non-reference image data and reference image data.

Unlike the forgoing first example, after non-reference image data F1x and F1y as continuously captured by imaging device 2 with exposure time T2 are transmitted and stored in image memory 5, reference image data F2 captured by imaging device 2 with exposure time T1 are transmitted and stored in image memory 5. At this time, similar to the first example, the non-reference image data F1x and F1y stored in image memory 5 are transmitted to displacement detection circuit 32 by which an entire motion vector M indicating an amount of displacement between the non-reference image data F1x and F1y is calculated.

When the entire motion vector M is transmitted to position prediction circuit 36, unlike the first example, reference image data F2 are obtained immediately after the non-reference image data F1y. Therefore, an entire motion vector M2, which indicates an amount of displacement between the non-reference image data F1y and the reference image data F2, is obtained. Namely, on the basis of the time difference Ta between timing at which non-reference image data F1x is read and timing at which non-reference image data Fly is read, a time difference Tc between timing at which non-reference image data F1y is read and timing at which reference image data F2 is read and the entire motion vector M indicating an amount of displacement between the non-reference image data F1x and F1y, the entire motion vector M2, which indicates an amount of displacement between the non-reference image data F1y and the reference image data F2, is calculated as: M×Tc/Ta.

Then, the entire motion vector M2 thus obtained by displacement prediction circuit 36 and the non-reference image data F1y stored in image memory 5 are transmitted to displacement correction circuit 33 by which displacement correction is performed on the non-reference image data F1y on the basis of the entire motion vector M2 to thereby generate non-reference image data F1w. Accordingly, image synthesizing circuit 34 generates synthesized image data F having a wide dynamic range on the basis of the data amount of each of the non-reference image data F1w and the reference image data F2, and stores the synthesized image data F in image memory 35. As a result, wide dynamic range image generation circuit 30 is operated to make it possible to obtain an image having a wide dynamic range wherein blackout in an image with a small amount of exposure and whiteout in an image having a large amount of exposure are eliminated.

### (Third Example of Operation Flow in Wide Dynamic Range Imaging Mode)

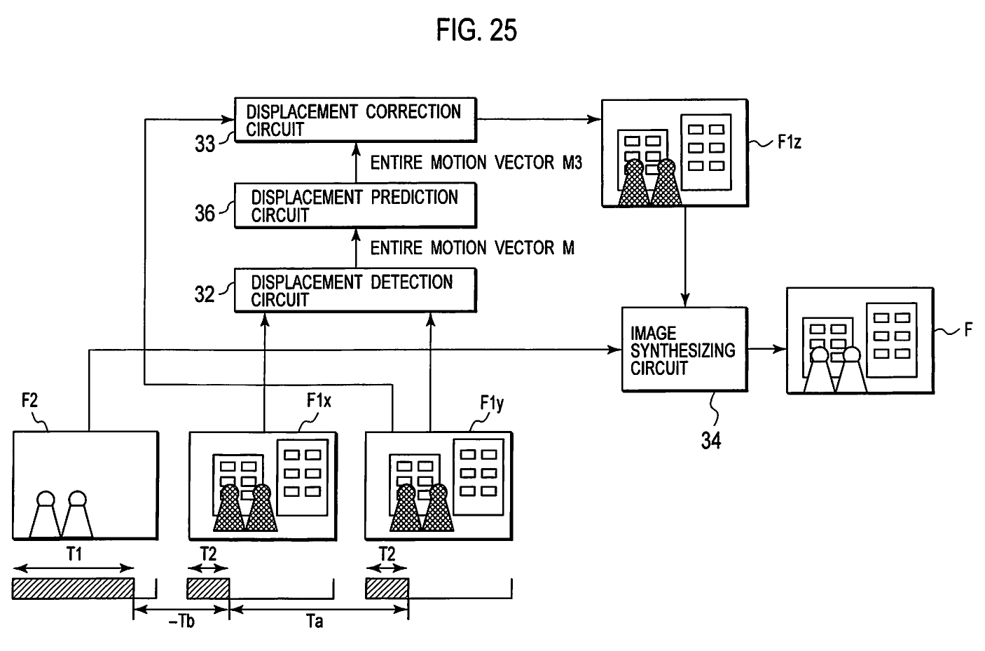

Moreover, the following will explain a third example of the operation flow of the entire apparatus when shutter button 21 is pressed in wide dynamic range imaging mode with reference to FIG. 25. In this example, imaging is performed in the order of reference image data, non-reference image data and non-reference image data.

Unlike the forgoing first example, after reference image data F2 captured by imaging device 2 with exposure time T1 are transmitted and stored in image memory 5, non-reference image data F1x and F1y continuously captured by imaging device 2 with exposure time T2 are transmitted and stored in image memory 5. At this time, similar to the first and second examples, the non-reference image data F1x and F1y stored in image memory 5 are transmitted to displacement detection circuit 32 by which an entire motion vector M indicating an amount of displacement between the non-reference image data F1x and F1y is calculated.

When the entire motion vector M is transmitted to position prediction circuit 36, unlike the first and second examples, reference image data F2 is obtained immediately before the non-reference image data F1x, and therefore an entire motion vector M3, which indicates an amount of displacement between the reference image data F2 and the non-reference image data F1x, is obtained. That is, on the basis of the time difference Ta between timing at which non-reference image data F1x is read and timing at which non-reference image data F1y is read, a time difference −Tb between timing at which reference image data F2 is read and timing at which non-reference image data F1 is read and the entire motion vector M indicating an amount of displacement between the non-reference image data F1x and F1y, the entire motion vector M3, which indicates an amount of displacement between the reference image data F2 and the non-reference image data F1x, is calculated as: M×(−Tb)/Ta. Thus, unlike the first and second examples, the entire motion vector M3, which indicates the amount of displacement between the reference image data F2 and the non-reference image data F1x, is a vector, which is directed opposite to the motion vector M indicating the amount of displacement between the non-reference image data F1x and F1y, and therefore has a negative value.

Then, the entire motion vector M3 thus obtained by displacement prediction circuit 36 and the non-reference image data F1x stored in the image memory 5 are transmitted to displacement correction circuit 33 by which displacement correction is performed on the non-reference image data F1x on the basis of the entire motion vector M3 to thereby generate non-reference image data F1z. Accordingly, image synthesizing circuit 34 generates synthesized image data F having a wide dynamic range on the basis of the data amount of each of the non-reference image data F1z and the reference image data F2, and stores the synthesized image data F in image memory 35. As a result, wide dynamic range image generation circuit 30 is operated to make it possible to obtain an image having a wide dynamic range where blackout in an image with a small amount of exposure and whiteout in an image having a large amount of exposure are eliminated.

As described in the foregoing first to third examples, when the imaging operation is performed in the wide dynamic range imaging mode, imaging time at which the non-reference image data F1x and F1y and the reference image data F2 are captured for each frame and may be different depending on exposure time, or may be the same regardless of exposure time. When the imaging time per frame is the same regardless of exposure time, there is no need to change scanning timing such as horizontal scanning and vertical scanning, allowing a reduction in operation load on software and hardware. Then, in the case of performing the operation as in examples 2 and 3, an amplification factor of displacement prediction circuit 36 can be set to almost 1 or −1, thereby making it possible to further simplify the arithmetic processing.

Moreover, in the case of changing the length of imaging time according to exposure time, it is possible to shorten imaging time on the non-reference image data F1x and F1y. In this case, the operation is performed as in the example 1, thereby making it possible to bring the amplification factor of displacement prediction circuit 36 close to 1 and further simplify the arithmetic processing. In other words, since it is possible to shorten imaging time on the non-reference image data F1y, displacement between the reference image data F2 and the non-reference image data F1x can be regarded as displacement between the non-reference image data F1x and F1y.

Furthermore, in the case of performing the imaging operation in the wide dynamic range imaging mode as in the foregoing example 1, synthesized image data F may be generated using the reference image data F2 and the non-reference image data F1y. At this time, when assuming that the length of imaging time is changed according to exposure time, imaging time on the reference image data F1y can be shortened, and therefore it is possible to suppress displacement between frames.

Moreover, in the foregoing first to third examples, the time difference between frames used in displacement prediction circuit 36 has been obtained on the basis of signal reading timing. To simplify the explanation, however, the time difference may be obtained on the basis of timing corresponding to a center position (time center position) on a time axis of exposure time of each frame.

The imaging apparatus of the embodiment can be applied to a digital still camera or digital video camera provided with an imaging device such as a CCD, a COS sensor, and the like. Furthermore, by providing an imaging device such as the CCD, the CMOS sensor and the like, the imaging apparatus of the embodiment can be applied to a mobile terminal apparatus such as a cellular phone having a digital camera function.

The invention includes embodiments other than those described herein in the range without departing form the sprit and scope of the invention. The embodiments are described by way of example, and therefore do not limit the scope of the invention. The scope of the invention is shown by the attached claims and are not all restricted by the text of the specification. Therefore, all that comes within the meaning and range, and within the equivalents, of the claims hereinbelow is therefore to be embraced within the scope thereof.

What is claimed is:

1. An imaging apparatus comprising:
a displacement detection unit configured to receive a reference image data of an exposure time and a non-reference image data of shorter exposure time than the exposure time of the reference image data, and to compare the reference image with the non-reference image to detect an amount of displacement;
a displacement correction unit configured to correct the amount of displacement of the non-reference image data based upon the amount of displacement detected by the displacement detection unit;
an image synthesizing unit configured to synthesize the reference image data with the non-reference image data corrected by the displacement from the displacement correction unit to generate the synthesized image data.

2. The imaging apparatus as claimed in claim 1, further comprising:
a luminance adjustment unit configured to amplify or attenuate at least one of the reference image data and the non-reference image data, in order to substantially equalize the average luminance values of the reference image data and the non-reference image data,
wherein the displacement detection unit detects the amount of displacement between the non-reference image data and the reference image data as adjusted by the luminance adjustment unit.

3. The imaging apparatus as claimed in claim 1,
wherein the non-reference image data is first and second non-reference image data of two images with the same exposure time,
the displacement detection unit detects an amount of displacement of each of the first and second non-reference image data, and calculates an amount of displacement between the first non-reference image data and the reference image data on the basis of a ratio of the time differences between the time difference of imaging timing of the first and second non-reference image data, and the time difference of the imaging timing of the first non-reference image data and the reference image data;
the displacement correction unit corrects the displacement of the first non-reference image data on the basis of the amount of displacement calculated by the displacement detection unit; and
the image synthesizing unit synthesizes the reference image data and the non-reference image data on which displacement correction has been performed in the displacement correction unit in order to generate the synthesized image data.

4. The imaging apparatus as claimed in claim 3, wherein imaging timing of the reference image data is set between the imaging timings of the first and the imaging timing of the second non-reference image data.

5. The imaging apparatus as claimed in claim 3, wherein the imaging timings of the first and the second non-reference image data are continuous.

6. The imaging apparatus as claimed in claim 1, comprising:
an imaging device that photoelectrically obtains image data, and outputs the image data; and
an image memory that temporarily stores the image data transmitted from the imaging device,
wherein the non-reference image data and the reference image data stored in the image memory are transmitted to the displacement detection unit, the displacement correction unit and the image synthesizing unit.

7. An imaging method comprising:
receiving a reference image data of an exposure time and a non-reference image data of shorter exposure time than the exposure time of the reference image data;
comparing the reference image with the non-reference image to detect an amount of displacement;
correcting displacement of the non-reference image data based upon the amount of displacement detected; and
generating synthesized image data from the reference image data by correcting with non-reference image data and displacement data.

8. The imaging method as claimed in claim 7, further comprising:
amplifying or attenuating at least one of the reference image data and the non-reference image data in order to substantially equalize the average luminance values of the reference image data and the non-reference image data,
wherein the displacement detection includes detecting an amount of displacement between the non-reference image data and the reference image data.

9. The imaging method as claimed in claim 7,
wherein the non-reference image data is first and second non-reference image data of two images with the same exposure time, and
in the displacement detection step, an amount of displacement of each of the first and second non-reference image data is detected and an amount of displacement between the first non-reference image data, and the reference image data is then calculated on the basis of a ratio of the time differences between the time difference of the imaging timing of the first and second non-reference image data, and the time difference of the imaging timing of the first non-reference image data and the reference image data;
in the displacement correction step, the displacement of the first non-reference image data is corrected on the basis of the amount of displacement calculated by the displacement detection unit; and
in the image synthesizing step, the reference image data and the non-reference image data on which the displacement correction has been performed are synthesized in the displacement correction step in order to generate the synthesized image data.

10. The imaging method as claimed in claim 9, wherein imaging timing of the reference image data is set between the imaging timings of the first and the second non-reference image data.

11. The imaging method as claimed in claim 9, wherein the imaging timings of the first and the second non-reference image data are continuous.
